(19) United States
(12) Patent Application Publication
(10) Pub. No.: US 2002/0123945 A1
(43) Pub. Date: Sep. 5, 2002

(54) Cost and performance system accessible on an electronic network

(76) Inventors: Jonathan M. Booth, Evanston, IL (US); John J. Urbanik JR., Schaumburg, IL (US)

Correspondence Address: BELL, BOYD & LLOYD, LLC, PO BOX 1135, CHICAGO, IL, 60690-1135, US

(21) Appl. No.: 09/798,483

(22) Filed: Mar. 3, 2001

(51) Int. Cl. G06F 17/60

(52) U.S. Cl. 705/30

(57) ABSTRACT

The system of the present invention includes one or more servers which communicate with one or more data storage devices and one or more programs. The storage devices include the activity data necessary for the system to generate results derived from a multi-driver cost system (such as activity-based costing) for a plurality of different users. Preferably, a plurality of users can provide raw general ledger data and other user-specific data to the system through a network, and the system, using its activity data associated with these types of users, can provide the users with cost and performance results in various forms. The system can automatically update the results for users from time to time.

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The present invention relates generally to a system which provides system users with cost and performance information and, more specifically, to a system accessible on a network, which enables users to submit cost information from their general ledgers or other sources and to receive cost and performance information related to activities, products, services and customers, preferably derived through a multi-driver cost system, such as activity-based costing.

Companies use cost systems to receive information about their income, expenses, profitability and their overall success. Cost systems operate by apportioning overhead to products and services. Under the traditional cost system, a company chooses a single factor, single allocation basis or single cost driver related to its products or services. The term, “cost driver,” as used herein, includes any factor or information which (based upon one or more logical, rational or causal relationships) can be used to measure the quantity of one or more activities or resources consumed or used by another activity, a product, a service or a customer. Some typical cost drivers are the amount of direct labor, direct material or tonnage (weight), or the number of units sold. As the cost driver increases, the overhead allocation increases. For example, a consumer products company may sell soup and crackers, using the tonnage cost driver in its cost system. Accordingly, any overhead, such as electricity, will be apportioned to the soup at a much higher percentage than the crackers because a can of soup weighs much more than a box of crackers.

This is an example of how the traditional cost system can generate distorted cost information. This traditional cost system fails to take into account the different types of activities which are required to manufacture the soup and the crackers. The activities in manufacturing the soup may involve mixing and canning while the activities in manufacturing crackers may involve mixing, conveying, baking, cutting and packaging. The cracker activities actually consume much greater amounts of electricity when compared to the soup activities. When a single cost driver (in this case, tonnage) is used, the cost system cannot take into account the different types of activities involved in manufacturing the soup and crackers.

For this reason and others, the traditional cost system can cause significant costing distortions and poor strategic decisions. Another reason why the traditional cost system is unreliable is that with the increased role of automation and computer technology, indirect activities have generally now become more significant factors than direct activities. For example, computer system processing for a manufacturing plant may be more costly than direct labor for the plant because the computer system may control the robots which handle most of the assembly. For all of these reasons, it became apparent that a new cost system was needed.

In response, an activity-based cost system (commonly known as activity-based cost, activity-based costing or ABC) was developed to take into account all of the primary or key activities related to a company's products and services. ABC is a multi-driver cost system because it uses a plurality of cost drivers to allocate overhead to a plurality of activities, providing companies with accurate and detailed cost information. In order to use ABC or a similar multi-driver cost system, a company must generate certain activity data peculiar to such a cost system. The term “activity data,” a used herein includes data or information related to one or more activities of a user, preferably including the identification of activities and related cost drivers. The term “user,” as used herein, includes a person or group of people, an entity or a portion of an entity, or otherwise any organization, business, company or representative of the foregoing.

Since the emergence of ABC, different types of ABC software have been developed for companies. Though companies can purchase or license this software, many companies lack the know-how, time or resources to actually implement, operate and support a multi-driver cost system such as ABC. To implement ABC, a company must review and analyze its entire business, including all of its activities, products and resources. Furthermore, using ABC or similar expertise, the company must identify, analyze, classify and generate activity data. In addition, the company must operate and support its ABC cost system which requires ABC expertise and may require significant effort to keep the cost system information up-to-date.

Presently, ABC is unattainable to a relatively large percentage of companies because they find it unfeasible and impractical to implement and support ABC. Today, in the United States a relatively small percentage of fortune five hundred companies use ABC. An even smaller percentage of medium sized and small companies use ABC. Consequently, there is a need to facilitate the implementation of ABC or another multi-driver cost system and to operate and support this type of cost system for companies and others, through use of a convenient cost and performance system.

### SUMMARY OF THE INVENTION

The present invention overcomes the above shortcomings by providing a cost and performance system (at times referred to herein as “cost and performance system” or “system”). The system includes one or more servers which electronically communicate with one or more permanent storage devices, a plurality of temporary storage devices and one or more system programs. A user can access the system through a network, such as the Internet. The term “storage device,” as used herein, includes a database or other device capable of storing data. The term “network,” as used herein, includes any information delivery vehicle, preferably based upon a client-server model. Preferably, the network is the World Wide Web portion of the Internet.

In one embodiment, a user connects to a network, such as the Internet, and accesses the system. Preferably, the system automatically transfers a copy of certain user-specific data from the user's on-site storage device to the system's storage device. Alternatively, through a plurality of interfaces, the system can prompt the user to enter such user-specific data. The user-specific data preferably includes data from the user's general ledger and other data specific to the user. After receiving the user-specific data, the system processes the data, using its programs and storage devices, and provides the user with results. The results include information related to the cost and performance of the user's operations, activities, products and customers. Preferably, the results include one or more reports and/or graphs which assist the user in identifying operational inefficiencies and opportunities for strategic profit-maximizing decisions.

The one or more servers or processors of the system generate the results by reading one or more system programs and electronically communicating with one or more storage devices. Preferably, a server hosts a website which a user can access through the Internet in order to input information and obtain results.

The system's one or more permanent storage devices preferably store: (a) activity data in one or more activity databases; (b) user-specific data in one or more user databases; and (c) specification data in one or more model specification databases. It is preferable that the system includes a plurality of different types of standard activity data separated into different categories, templates or dictionaries which is applicable to or associated with different types of users. With standard activity data being stored within the system, the system enables various users, preferably of various types, to implement ABC or other multi-driver cost systems without having to review and analyze their type of operations and generate activity data. In recognition of the fact that certain types of users carry out similar activities, the system preferably includes the standard activity data which particular types of users need to implement ABC or another multi-driver cost system.

Activity data can be acquired or generated in any suitable manner. Preferably, the implementor of the system generates standard activity data by auditing and interviewing users. Preferably, the implementor need only gather data once for each category or type of user. It should be appreciated that this data can be acquired or generated electronically by accessing user databases and/or third-party databases.

Preferably, the system includes a plurality of activity databases for storing different templates or categories of activity data. For example, the system can include an automotive industry activity database, grocery store activity database, beer distributor activity database, banking industry activity database, health care industry activity database and fast food industry activity database. Preferably, the system includes different categories of activity data, stored in separate tables in a single database or stored in separate databases. With the system providing the standard activity data for users, users do not need to generate, acquire or provide any activity data in order to obtain results from a multi-driver cost system. Preferably, at the user's option, the system enables the user to supplement the standard activity data with certain user-specific activity data.

In one embodiment, the system's user database preferably includes a backup copy of the user's on-site database. The user database also preferably includes a user archive database. The user archive database includes a copy of certain data provided by the user in the past. For example, if a user has been using the system for two years, the user archive database may include two years of historical data. This enables the system to generate results which include comparisons to past cost and performance data. This also enables the system to detect when a user inputs erroneous data. For example, if a user has traditionally input a certain level of cost for a certain general ledge account, if the user inputs an amount for that account which is disproportionately higher than the previous amount, the system can warn the user to double check that input.

The specification data stored in the model specification database specifies a type of cost model for the model builder program described below. Depending upon the type of model builder program used, the server can build one of a variety of types of models. In one embodiment, the specification data specifies a model which is constructed by allocating all general ledger accounts to operational activities and enterprise sustaining activities, breaking out certain accounts into sub-accounts. The specification data further specifies constructing the model by classifying as operational activities those enterprise sustaining activities which constitute a cost-of-doing business. The specification data then specifies constructing the model by allocating operational activity overheads to cost objects, such as products, services, activities and customers as the overheads rationally relate to such cost objects. Also, the specification data specifies the model by allocating enterprise sustaining activity overheads to cost objects, such as products, services, activities and customers.

The temporary storage devices which the server also uses to generate the results preferably include a plurality of different databases which have different roles. For the temporary storage devices, data only remains in the devices long enough for the server to use that data for a particular result generation or run. After that data is used for a particular run, the server erases the data or will replace it with subsequent data when generating different results at a different time. In one embodiment, the temporary storage devices include an input database, an input converted database, a holding database, a model database and an output converted database. The server uses these databases in conjunction with various system programs.

The system programs can include one or more computer programs which enable the server, with access to certain data, to generate the results. Preferably, the system includes a plurality of system programs including a receiving program, an input conversion program, a command program, a cost program (preferably a model builder program), an output conversion program, and an enhancement and formatting program. It should be appreciated, however, that the system can operate with a single system program which enables the server to generate the results.

The server uses the receiving program or another suitable program to collect data from the user. In a preferred embodiment, the system automatically retrieves a copy of the user's raw general ledger data from the user's on-site database, and the system enables the user to manually input certain operational user-specific data through a plurality of interfaces. In an alternative embodiment, the user manually provides all user-specific data, including all general ledger data, through a plurality of interfaces. In any case, the server stores the user-specific data in the input database. Next, the server uses the input conversion program to put the data from the input database into a form acceptable for the model builder program. This data is then stored in the input converted database. The server then uses the command program to divert certain portions of this data to the holding database, as instructed by the model builder program. The server uses the model builder program to retrieve data from the holding database and generate model data. The server then stores the model data in the model database. Next, the server uses the output conversion program to convert this data into a form which provides activity overheads and product overheads as they relate to specific activities, products, services and customers of the user. Finally, the server uses the enhancement and formatting program to add meaning to the results, preferably by augmenting the data with financial and non-financial statistics and other information related to the user's operations and by generating graphs and reports.

In a preferred embodiment, the input conversion program includes one or more allocation algorithms which it uses for the input conversion. Each algorithm includes one or more cost drivers and results in the calculation of an allocation quantity. The allocation quantities include factors which are used to apportion general ledger accounts or overheads to certain activities and/or products. Specifically, the allocation algorithms include the appropriate cost drivers necessary to calculate: (a) activity allocation quantities which are associated with a particular general ledger account and type of activity; and (b) product allocation quantities which are associated with a particular activity and type of product.

Preferably, the algorithms incorporate at least two types of cost drivers, resource cost drivers and activity cost drivers. To illustrate this concept in an example, a general ledger resource could be an expense of fifty thousand dollars for data processing. In this example, a resource cost driver could be the amount of processing time. The allocation algorithm would take into account the processing time consumed by the user's various activities to calculate various activity allocation quantities. These quantities are preferably calculated in percentage form. As such, by multiplying the activity allocation quantity by the resource overhead, which in this case would be fifty thousand dollars, the server, using the model builder program, can calculate various activity overheads. The allocation algorithms can also include weight factors in order to account for differences between the nature of various resources or the nature of various activities.

Based upon these allocation quantities calculated by the input conversion program, the server uses a cost program, preferably the model builder program along with model specifications, to calculate product and service overheads. In one embodiment, the cost program is a model builder program. Preferably the model builder program is a commercially available activity-based program known as ABC Oros by ABC Technologies, Inc. This model builder program is capable of building different types of models, depending upon the type of model specifications provided to it.

In one embodiment, when a user desires to obtain results from the system for the first time, the user must apply for an account through the system, preferably by accessing the system at a system website. When the user applies to open an account, the system will verify that it has the standard activity data to accommodate the user. If the system does not have such data, the system can be adapted to electronically retrieve the activity data from the user and/or other third-party databases.

It should be appreciated that the system can be separately operated by implementors in various industries or fields. For example, an automotive retailer implementor may enable automotive retailers to access an automotive retailer system website, and a banking implementor may enable banks to access a bank system website. Alternatively, a general accounting or costing implementor may enable various types of users to access various types of system websites.

In any case, with the system having the activity data to accommodate a particular user, the system implementor will open an account for the user. Using the receiving program or another suitable program, the server will preferably then automatically obtain user-specific data (specifically, general ledger data) from the user's on-site database. Through a plurality of interfaces, the system then enables the user to supplement the standard activity data with user-specific activity or operational data. Alternatively, the server may enable the user to enter all user-specific data through a plurality of interfaces. Once the server has obtained the user-specific data, the system will enable the user to copy certain data from the system's permanent storage databases onto the user's on-site database. Preferably, the server will also enable the user to download certain system reference data and the appropriate standard activity data onto the user's on-site database. This data will enable the system to provide the user with support and updated results, as described below.

Next, the server uses the input conversion program to convert the user-specific data into a form acceptable by the model builder program. Preferably, the model builder program is an activity-based program. However, the model builder program can include any type of program which apportions or allocates overhead cost, preferably through the use of multiple cost drivers and one or more theoretical or database models. The server then uses the output conversion program to convert the data into a format which provides activity and product overhead cost information relevant to the various cost objects of the user, such as activities, products, services and customers. Finally, the server uses the data enhancement and formatting program to make the data more meaningful to the user. Preferably, this is accomplished by augmenting the data with industrial or statistical data and by generating reports, graphs and other visual representations of the data. This enhanced and formatted data and information constitutes the results.

If the user inputs information and data through the interfaces, the system reviews the data for any errors. Preferably, the system checks to ensure that the data, as entered by the user, corresponds to the general ledger accounts. For example, if an electric utility account were one hundred thousand dollars on the general ledger, this amount must correspond to the various activities to which the one hundred thousand dollars was allocated. If the system detects an error, the system will warn the user or otherwise inform the user about the error and how to correct such error. It should be appreciated that the system will conduct a plurality of error checks from the moment a user inputs data to the end, when the system generates results.

After the system has generated results for the user, the user can access these results any time, preferably by logging onto the Internet and visiting the website of the system. In addition, a user can obtain updated results on a periodic basis or at the will of the user. This updating can occur in a variety of manners. For example, on a monthly, quarterly or annual basis, a user administrator can visit the system website and enter new user-specific data and obtain updated results. In another example, on a periodic basis, the system can distribute surveys for certain employees of users, receive completed surveys from the users, and the implementors of the system can input new user-specific data into the system on behalf of the users. The users can then access updated results at any time. In another embodiment, at periodic intervals or when a predetermined event occurs, the server will automatically communicate with the user's database and extract new user-specific data. The system will then generate new results based upon this new user-specific data. The user can access these results at any time in real-time.

By obtaining user-specific data, preferably from the user's on-site database, the cost and performance system of the present invention enables a user to obtain detailed information related to cost and performance, including, without limitation, information related to activities, products, services, customers and opportunities. The system enables users who lack a working knowledge of ABC or other multi-driver cost systems to obtain this information preferably without having to generate activity data themselves for such a cost system. Furthermore, the system preferably includes a variety of categories of standard activity data to accommodate various types of users, such as users in various industries. To use the system, preferably the system automatically retrieves user-specific data from a user's on-site database, and with this data and the system's standard activity data, the system generates results for the user. Also, users can review the results in real-time by accessing the system on a network, and the system can automatically update the data and results for the users. This type of system makes it practical and convenient for users to obtain cost and performance information generated through a multi-driver cost system such as activity-based costing.

It is therefore an advantage of the present invention to provide a cost and performance system which is accessible on an electronic network;

Another advantage of the present invention is to facilitate the implementation of activity-based costing and other multi-driver cost systems by including standard activity data within the system;

Yet another advantage of the present invention is to provide a system for obtaining cost and performance information derived through a multi-driver cost system, such as ABC, which accommodates different types of users, such as users in different industries;

Another advantage of the present invention is to provide users with convenient network access to and automatic updating of cost and performance information derived through a multi-driver cost system, such as ABC;

Yet another advantage of the present invention is to effectively and automatically calculate a plurality of allocation quantities for overheads using appropriate algorithms, activity cost drivers and resource cost drivers;

Another advantage of the present invention is to provide users with a convenient and practical system which provides insightful performance metrics, financial and productivity analyses and benchmark performance analyses;

Yet another advantage of the present invention is to provide users with a convenient and practical system which enables them to identify profit maximization opportunities which typically have been unrepresented or misrepresented by traditional cost systems; and

Another advantage of the present invention is to provide users with a system which conveniently integrates into the users' existing cost systems to provide cost and performance information derived through a multi-driver cost system, such as ABC.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is a schematic diagram of one embodiment of the system of the present invention;

FIG. 2 is a flow diagram of the system operation in one embodiment of the system of the present invention;

FIGS. 3 is a schematic diagram of the databases and system programs in one embodiment of the present invention;

FIG. 4 is a schematic diagram of an organization database in one embodiment of the present invention;

FIG. 5 is a schematic diagram of an on-site database in one embodiment of the present invention;

FIG. 6 is a flow diagram of activity data generation in one embodiment of the present invention;

FIG. 7 is a flow diagram of model specification in one embodiment of the present invention;

FIG. 8 is a schematic diagram of various types of data used to generate various types of results in one embodiment of the present invention;

FIG. 9 is a table of error detection algorithms in various embodiments of the present invention;

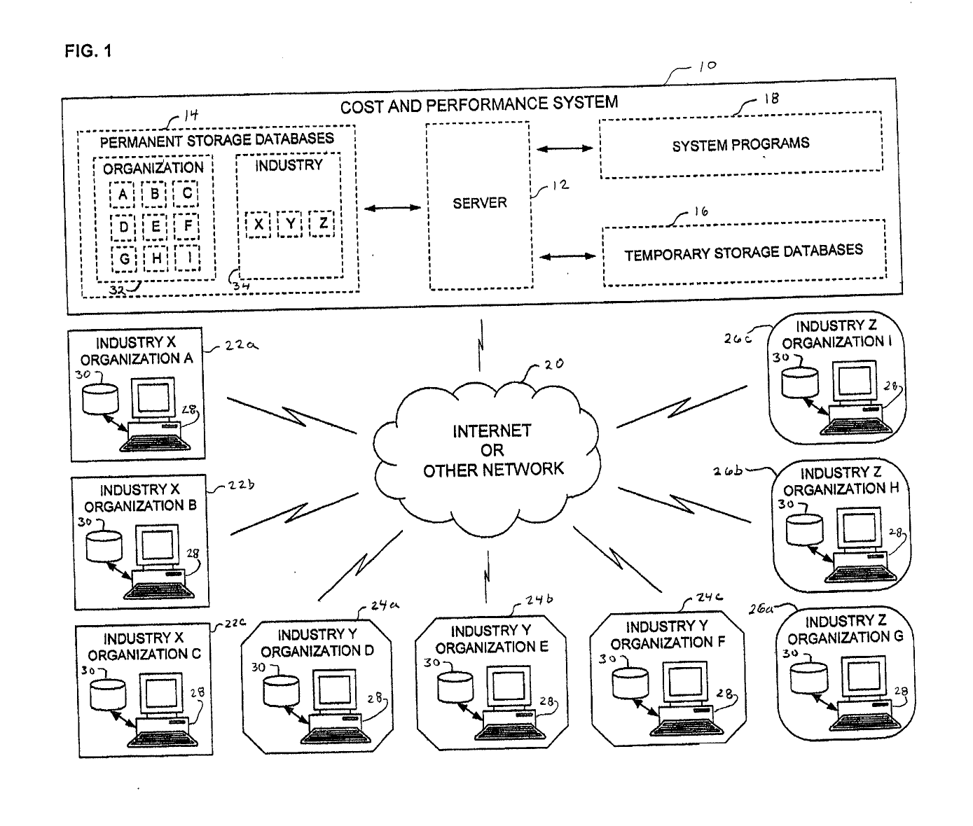

FIGS. 1OA through 10C are tables of allocation algorithms in various embodiments of the present invention;

FIG. 11 is a schematic diagram of input conversion and model building in one embodiment of the present invention;

FIGS. 12A through 12B are tables of various embodiments of the present invention illustrating result comparisons between traditional cost systems and the system of the present invention; and

FIGS. 13 through 67 are example interfaces of one embodiment of the present invention.

### DETAILED DESCRIPTION OF THE PRESENTLY PREFERRED EMBODIMENTS

### I. System

The cost and performance system of the present invention includes one or more servers which are electronically connected to: (a) one or more permanent storage devices; (b) a plurality of temporary storage devices; and (c) one or more system programs. The server or processor is connected to a network which can be any information or communication delivery vehicle, including without limitation, a local area network, wide area network or any other type of communication channel. Preferably, the network is the Internet, including any portion of the Internet such as the World Wide Web or the high speed portion of the Internet under development commonly known as Internet2, or any intranet which provides entities and users with access to the Internet. A user can access the network with any processor including, without limitation, a computer or hand-held device. Preferably, a user can access the network by operating a client computer which includes any computer system connected to the network which enables a user to send and receive information from any server on that network. Preferably, the client computer is a personal computer or other Internet access device which includes the contemporary browser software necessary to send and receive information from servers over a network.

The connections between the server and the network and the user's processor and the network can include any suitable communication channel including, but not limited to, hardwire lines, wireless communication, dial-in telephone lines, digital subscriber lines (DSL), fiber optics, satellites or high speed cables.

The server itself can include any processor or any computer system, such as a main frame computer system. Preferably, the server or processor is adapted to send and receive data to and from various memory devices, including read only memory (ROM) devices and random access memory (RAM) devices. The server or processor of the system can operate on any suitable platform or operating system.

The storage devices included in the system are preferably databases, however, it should be appreciated that the storage devices can include any other type of device which can electronically store data or information. Preferably, the databases included within the system are relational databases which store information in the form of tables. It should be appreciated, however, that other forms of databases can be employed with the present invention. The system programs of the system include computer code or one or more programs which are readable by the server. The server uses the system programs in conjunction with the databases to process data as described below.

The system also stores activity data within one or more of the permanent storage devices. In a preferred embodiment, the system includes at least one general type of activity data which is associated with or applicable to a particular type of user. This general or standard activity data (which may be thought of as a standard template or dictionary) can be used multiple times by different users of the same type. For example, the system may include standard banking activity data which all banks can use or standard health care activity data which all health care providers can use. If a user has in the past employed a traditional cost system or a cost system other than a multi-driver cost system or ABC, the user must obtain activity data in order to change to a multi-driver cost system such as ABC. The standard activity data thus functions as an adapter, enabling a user to transition from a traditional cost system to a multi-driver cost system such as ABC. The system of the present invention includes this standard activity data within its storage devices for the benefit of users.

The standard activity data associated with a particular type of user includes all of the activity data which the system requires in order to generate results for the user. It is preferred that the system provides the user with the option of supplementing the standard activity data with certain user-specific activity data.

Preferably, the system will include the standard activity data before a user first uses the system, thereby eliminating the need for a user to generate this data on its own. The standard activity data can be generated in any suitable manner, however, preferably standard activity data is generated by auditing or examining the operations and financial records of a plurality of organizations or enterprises, as described in detail below. It should be appreciated that although in one preferred embodiment this auditing and examination is conducted through human interaction, it can also be conducted electronically, partially or wholly. For example, electronic auditing may involve the server obtaining data from one or more third party databases, in addition to the on-site databases of organizations or enterprises. Such third party databases may include public information or private information regarding a particular industry or field of operation. Preferably, the implementor of the system need only generate or acquire activity data once for a particular type of user, resulting in standard activity data. On multiple occasions, multiple users of the same type can use the resulting standard activity data.

Preferably, the system automatically acquires user-specific general ledger data from the user's on-site database. In an alternative embodiment, the system collects user-specific general ledger data from a user through a plurality of interfaces. In either case, through a plurality of interfaces, the system preferably enables the user to supplement the standard activity data with certain user-specific activity data.

Preferably, the user can access the system by visiting a pre-determined system website on the Internet. At that website, the user can access these interfaces and submit user-specific data. After the user has entered the data, the system will check for erroneous entries and prompt the user to eliminate any errors. After the system has obtained error-free user-specific data, the server will conduct an input data conversion, which puts the data in a format acceptable for model building. Next, the server will build the model. The server then conducts output data conversion. This is followed by data enhancement and formatting. At this point, the system generates results which are accessible by the user at any time. The user can then update these results by submitting new data through the interfaces from time to time. In addition, the system can automatically obtain new data from the user's on-site database and generate updated results periodically.

One embodiment illustrated in FIG. 1 involves a plurality of users which are organizations. With reference to FIG. 1, the system 10 includes a server 12, which communicates with a plurality of permanent storage databases 14, a plurality of temporary storage databases 16 and a plurality of system programs 18. The system 10 is connected to a network 20, preferably the Internet. A plurality of organizations operating in a plurality of different industries are also illustrated in FIG. 1. Organizations 22a, 22b and 22c operate in industry X, organizations 24a, 24b and 24c operate in industry Y and organizations 26a, 26b and 26c operate in industry Z. Preferably, each of these organizations includes at least one user or organization processor 28 which is electronically connected to at least one on-site database 30. The organization processors 28 are each connected to the network 20. It should be appreciated that the server 12 and various organization processors 28 included in this embodiment can be connected to the network 20 through any suitable device or channel. The preferred connection is a high speed cable or dial-in telephone connection.

As illustrated in FIG. 1, the permanent storage databases 14 include a plurality of organization databases 32 as well as a plurality of industry databases 34. As described below, the organization databases 32 preferably include a backup copy of each organization's on-site database 30 and an archive database designated for each organization. The industry databases 34 include the standard activity data separated by industry from database to database. For example, the system can include an automotive retailer database, a banking database, a grocery store database, a beer distributor database and/or a fast food database. Each of these databases would include the standard activity data which relates to a particular industry. Though FIG. 1 illustrates three industry databases 34 and six organizations, it should be appreciated that this is merely an illustration and that the system can include any number of user or organization databases and any number of activity databases or industry databases.

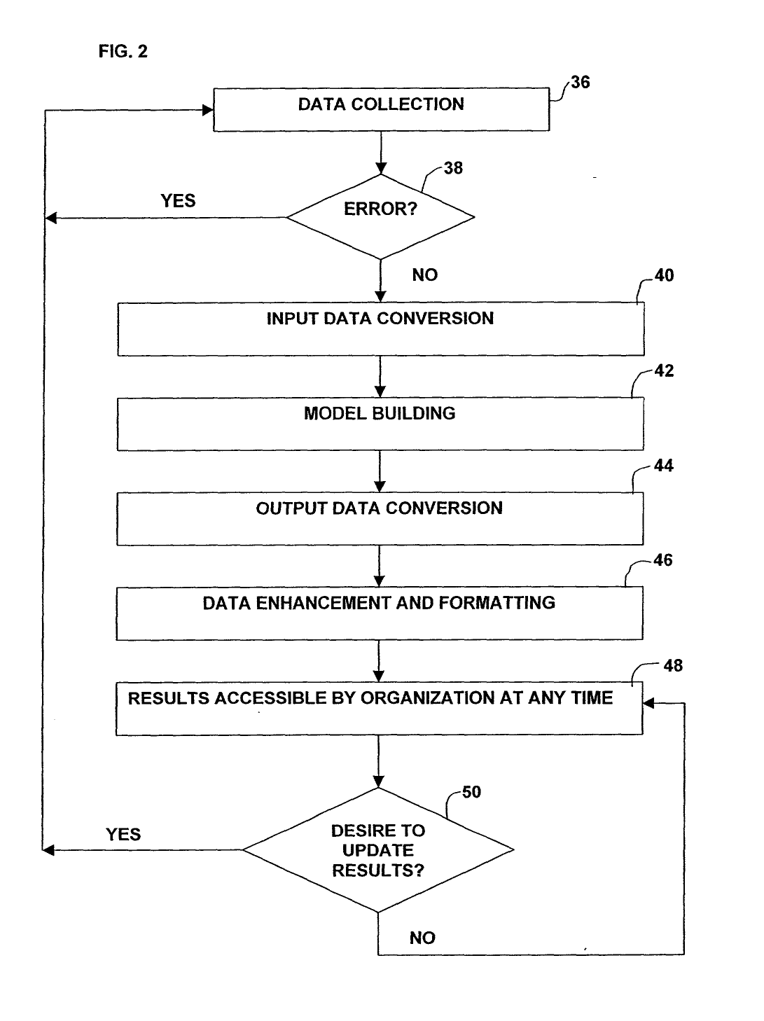

With reference to FIGS. 1 and 2, in one embodiment the system enables an organization to access the server 12 through the network 20. Preferably, the organization does so by logging onto the Internet and hyperlinking to a system website (not shown) which is hosted by the server 12 or any other server. In a preferred embodiment, the server 12 automatically obtains organization-specific raw general ledger data from the organization's on-site database 30, as indicated by block 36. In an alternative embodiment, the organization will be able to input organization-specific raw general ledger data through a plurality of interfaces as indicated by block 36. In addition, through a plurality of interfaces, the system enables the organization to supplement the system's standard activity data with certain organization-specific activity data, also as indicated by block 36. The server will review the entries made by the organization for errors, and if the server detects errors, it will warn or notify the organization with an audio and/or visual message. As indicated by diamond 38, preferably the system will check to ensure that the financial and cost data, which the organization separately enters, corresponds to the total cost information in the organization's general ledger, a copy of which the server obtained from the organization's on-site database. Once the system detects no errors, the system will conduct an input data conversion as indicated by block 40.

The input data conversion involves putting the organization-specific data and activity data associated with the organization in a form which is acceptable for model building. Preferably, the input-data conversion, as discussed below, involves allocating general ledger accounts to various activities and various activities to various products, services, customers and other cost objects. As indicated by block 42, the server then performs the model building, resulting in model data. Next, the server performs the output data conversion as indicated by block 44. The output data conversion is necessary to relate the activity and product overhead model data to the cost objects of the organization, such as activities, products, services and customers. The server then enhances and formats the data coming from the output conversion, as indicated by block 46. This step involves adding meaning to the data for the organization by augmenting the data with industry statistics and other information and presenting information in graphs and reports. As indicated by block 48, the system then generates results which are accessible by the organization at any time, preferably in real-time. As indicated by diamond 50, if there is a desire to update results, the organization can do so by submitting new data through the interfaces. Alternatively, on a periodic basis, the system can be set up to automatically obtain data from the organization's on-site database and generate new results. Of course, if there is no need to update the results, the organization will have continued access to the original results, as indicated by diamond 50.

### II. System Data

### A. Permanent Storage Databases

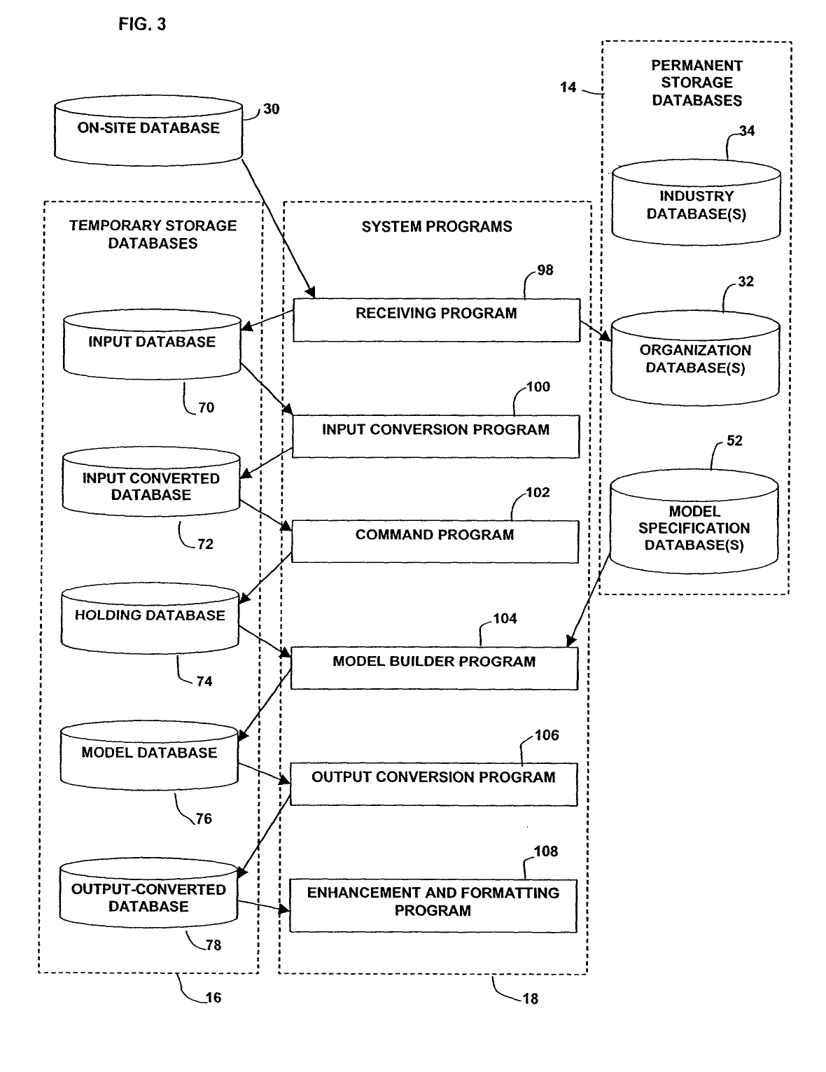

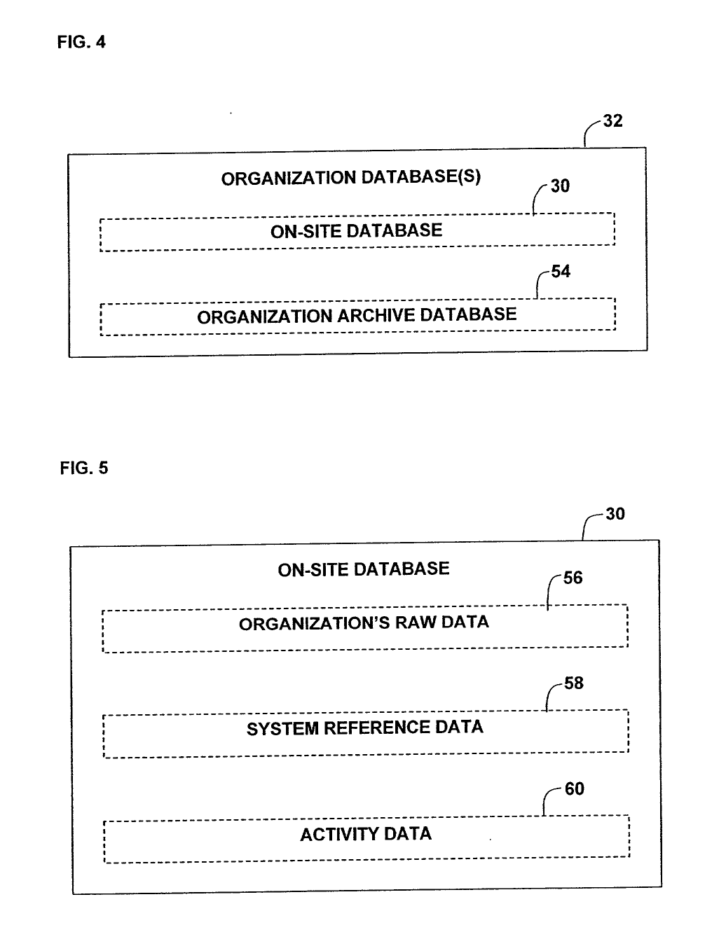

As described above, the system includes one or more permanent storage devices. In one embodiment illustrated in the FIGS. 3 through 5, the permanent storage devices or databases include a plurality of industry databases 34, a plurality of organization databases 32 and one or more model specification databases 52. Each organization database 32 includes a backup copy of the organization's on-site database 30 and an archive database 54 designated for that organization. The archive database 54 includes data related to past cost and performance of the organization. For example, if a user has been using the system for three years, the archive database 54 will store historical data of the user going back three years. The system can use this historical data to provide organizations with comparison and trend information in the results.

Preferably each on-site database 30 includes the organization's raw data 56, the system reference data 58 and the activity data 60. Preferably, before the organization used the system for the first time, the on-site database 30 only included the organization's raw data 54, but after the organization input its data through the interfaces, the system transferred system-reference data 58 and activity data 60 to the organization's on-site database 30. The system reference data 58 preferably includes reference numbers and tracking numbers which relate or tie the organization's raw data 56 to the other data included in the system.

### B. Activity data

The system includes standard activity data within one or more of its permanent storage devices or databases. In the embodiment illustrated in FIGS. 1 through 5, this standard activity data is stored within the industry databases 34. As such, an organization operating in a particular industry can use the system and obtain cost and performance information as long as the system includes standard activity data for that organization's particular industry. It is preferred that the system include standard activity data before the organization first uses the system, however, it should be appreciated that the system or a system implementor can generate or acquire standard activity data during or after the collection of data from the organization.

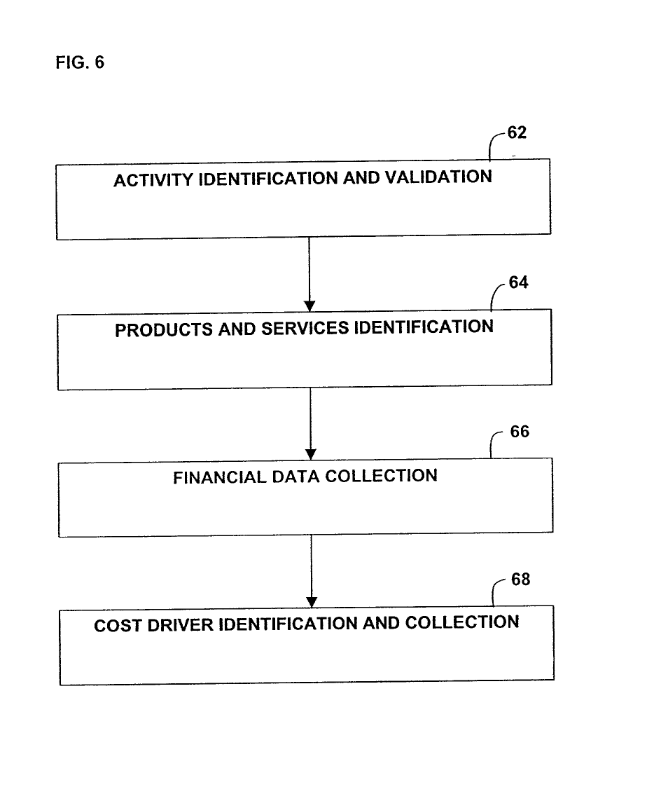

In a preferred embodiment, the system includes a plurality of categories of standard activity data appropriate for a plurality of different types of users. This standard activity data can be generated or acquired in any suitable fashion, including the use of manual and/or electronic data collection techniques. In one embodiment illustrated in FIG. 6, the standard activity data is generated for a particular type of organization through the steps of: activity identification and validation; products and services identification; financial data collection; and cost driver identification and collection. In the activity identification and validation step indicated by block 62, an implementor of the system identifies the activities required to conduct the day-to-day operations of the organization.

This step involves: (a) performing an ABC pilot study involving one or more organizations operating in the same or similar industry by interviewing managers and supervisors and sampling employees to develop an initial version of standard activity data; (b) using ABC expertise to modify the standard activity data in light of the appropriate level of activity detail to develop a second version of the standard activity data; (c) obtaining the reviews and comments from supervisors and managers regarding the standard activity data and developing a third version of the standard activity data in accordance with such reviews and comments; (d) specifying an ABC test model and generating and using one or more ABC models to identify which activities in the third version of the standard activity data are material or significant; (e) obtaining the reviews and comments from leaders, opinion leaders, industry experts or other respected authorities in the applicable industry regarding the third version of the standard activity data; and (f) formalizing the final version of standard activity data by creating nomenclature to identify and track activities by user tracking numbers and system tracking numbers.

Finally, the finalization of the standard activity data involves: assigning all general ledger accounts to activities so that only activities which are considered material remain in the activity list; grouping the activities into high level user operations such as department groupings; classifying the activities into activity groups where the activities within a group serve the same basic function (such as activities which involve product storage, for example); and classifying the activities into value chain activity categories. Preferably, these value chain activity categories include: department operational activities which involve moving products in and out of an organization; department sustaining activities which involve those activities which sustain the operations of a specific department; and dealer sustaining activities which involve those activities which sustain the overall operations of the organization, including operational activities such as manufacture reimbursement. In one embodiment, this step one resulted in one hundred thirty-two activities.

Step two, indicated by block 64, involves determining the cost objects for the user or organization. Specifically, this step involves determining the different types, brands and models of products, services and customers of the organization with the appropriate level of detail. In step three, indicated by block 66, the implementor of the system gathers and classifies the organization's financial information necessary to simulate the organization's revenue and cost flows. Preferably, the implementor of the system electronically accesses the organization's general ledger and obtains the necessary information. However, it should be appreciated that if necessary, the implementor can obtain this financial information manually.

In the fourth step indicated by block 68, the implementor of the system creates and classifies the appropriate cost drivers for the organization. The implementor limits the number of cost drivers based upon the balance of accuracy and effort using the 80/20 rule, focusing on identifying simpler cost drivers which approximately quantify how resources and activities are consumed versus relatively complex cost drivers which require a relatively high degree of effort. In one embodiment, this fourth step resulted in thirty-one distinct cost drivers.

### C. Temporary Storage Databases

Referring back to FIGS. 1 through 5, in one embodiment of the present invention, the system includes a plurality of temporary storage databases 16. Preferably, these databases include an input database 70, an input converted database 72, a holding database 74, a model database 76 and an output converted database 78. As described in detail below, these temporary storage databases 16 store data for a certain amount of time preferably for the purpose of generating a particular result for a particular user. When the system generates different results for different users, the data which was previously stored within the temporary storage database 16 is erased or otherwise replaced with the new data. This use of temporary storage databases 16 enables the server of the system to use one set of system programs 18 to generate a plurality of different results for different users. It should be appreciated, however that the system of the present invention need not include temporary storage databases 16. The system could operate without these temporary storage databases 16 by using a plurality of duplicate system programs 18. The particular temporary storage databases 16 illustrated in FIG. 3 serve different roles with respect to the system programs 18, as described in detail below.

### D. Model Specifications

In one embodiment of the present invention, as discussed above, the permanent storage devices or databases include one or more model specification databases. These databases include model specification data which determines what type of model the server will generate. Preferably, the system includes a plurality of different model specification databases, where each database is associated with a different type of model. In one embodiment, the system includes a database which includes generic model specifications. These generic specifications are applicable to any type of user. In other embodiments, the system includes a model specification database which includes specification data associated with a model appropriate for a particular type of user (such as a user in a particular industry or field).

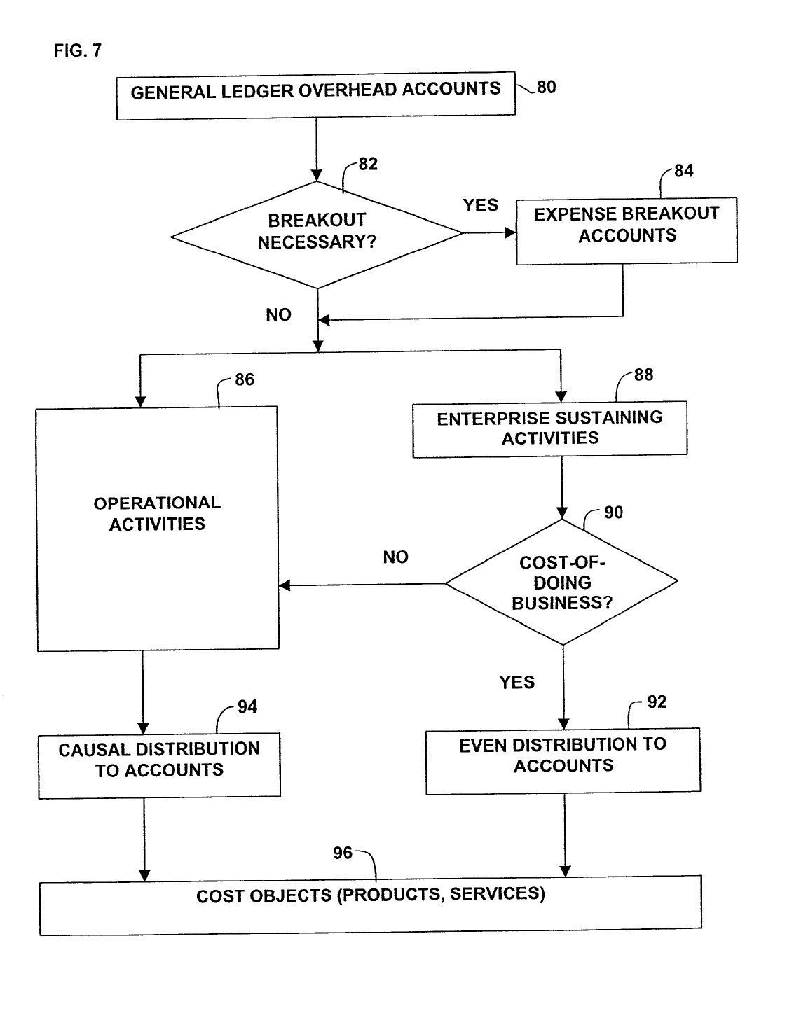

In one embodiment illustrated in FIG. 7, the model specification data assigns the user's general ledger overhead accounts to operational activities and enterprise sustaining activities, while breaking out or dividing out certain accounts into sub-accounts, as indicated by block 80, diamond 82, block 84, block 86 and block 88. The enterprise sustaining activities involve activities which are mandatory or necessary for the user or organization to conduct its day-to-day activities. The operational activities include those key activities which the user or organization regularly performs to ultimately deliver a product or service to their customers. The data specifications specify the model by then requiring the enterprise sustaining activities to be evaluated to determine which ones are considered cost of doing business activities as indicated by diamond 90.

The cost of doing business activities are activities which the user or organization conducts for the benefit of all facets of the organization. For example, the salary for a telephone operator for an organization would be considered a cost of doing business. The data specifications then specify the model by assigning the enterprise sustaining activities which are considered cost of doing business activities to the operational activities, as indicated by diamond 90 and block 86. The specifications further specify the model by requiring those enterprise sustaining activities which are considered cost of doing business activity overheads to be evenly distributed amongst the organization's cost objects, including activities, products, services and customers, as indicated by diamond 90 and block 92. As indicated by block 94, the data specifications further specify the model by requiring a causal distribution of all operational activity overheads to the organization's cost objects, including activities, products, services and customers. This causal distribution involves relating various activity overheads to various cost objects based upon rational relationships or cause and effect. For example, an automotive retailer may have activity overheads related to selling a vehicle brand A, such as preparing televised advertisement programs. The overhead for preparing programs for vehicle brand A would be tied or related to the particular product, vehicle brand A. Finally, as indicated by block 96, the data specifications specify the model to include cost objects including products, services and customers for which the various activities have ultimately been performed.

### III. System Programs

A. Operation

As described earlier, the system includes one or more system programs which the server uses to process data. Referring back to FIG. 3, in one embodiment the system includes a receiving program 98, input conversion program 100, command program 102, model builder program 104, output conversion program 106 and enhancement and formatting program 108. In operation, the server uses the receiving program 98 to establish communication with the on-site database 30 and receive a copy of the user's on-site database 30. The server will then store this back-up copy in the organization database 32. The server also uses the receiving program to provide the organization with a plurality of graphical user interfaces. As discussed earlier, the organization provides organizationspecific data, preferably the organization's general ledger, through these interfaces. In addition, the server uses the receiving program 98 to retrieve particular standard activity data from the industry database 34.

The server will then use the receiving program 98 to send the organization-specific data and standard activity data to input database 70. The server then retrieves the data from the input database 70 and uses input conversion program 100 to convert this data to a format acceptable for the model builder program 104. The server then uses the input conversion program 100 to send this data to input converted database 72. Next the server uses command program 102 to retrieve the data from input converter database 72. Using command program 102 and model builder program 104, the server incrementally stores certain portions of the input converted data into holding database 74. As instructed by the model builder program, the server retrieves data from the holding database 74 and feeds it into model builder program 104. The server uses command program 102 and holding database 74 to control the incremental input of data into the model builder program 104.

The server then generates model data using the model builder program 104 and sends this model data into model database 76. Using output conversion program 106, the server retrieves model data from model database 76 and converts it into a format which relates to the organization's overhead accounts. This data is then stored in output converted database 78. Finally, the server uses enhancement and formatting program 108 to retrieve the data from the output converter database 78. The enhancement and formatting program enables the server to add meaning to the results for the organization. Preferably, this is accomplished by incorporating statistical information, facts and other data into the results, along with presenting the results in the form of graphs, reports and other useful representations.

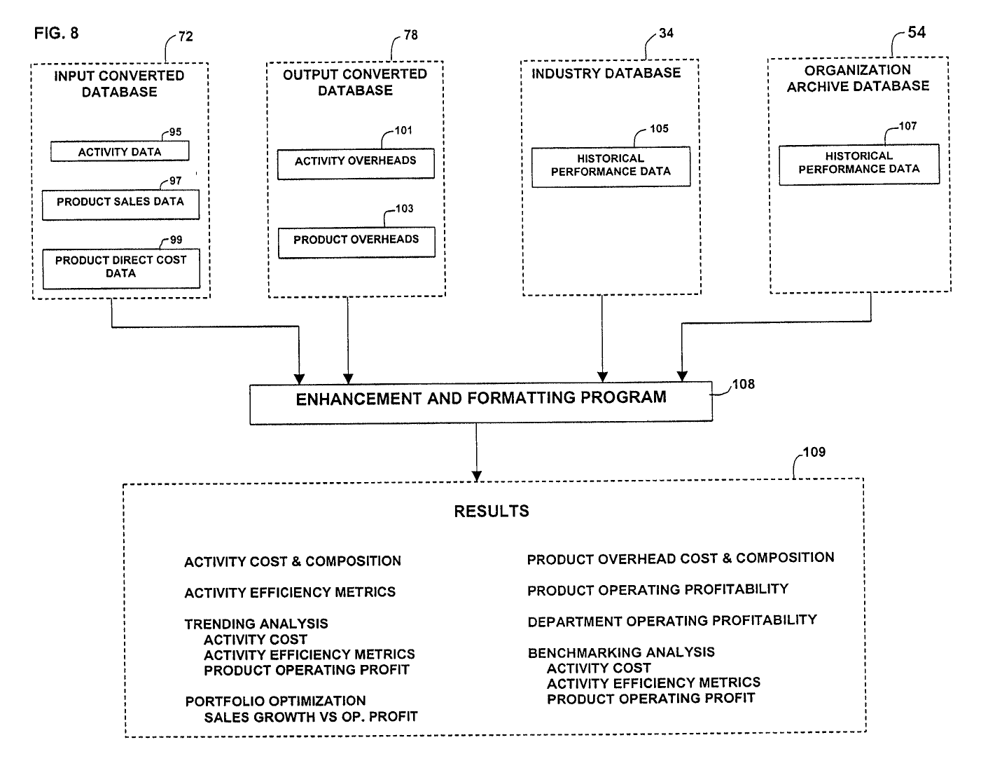

In one embodiment illustrated in FIG. 8, various types of data can be input into the enhancement and formatting program 108 for generating the results. Here, the input converted database 72 provides activity data 95, product sales data 97 and product direct cost data 99. Also, output converted database 78 provides activity overheads 101 and product overheads 103. In addition, industry database 34 provides historical performance data 105 which includes data related to industry performance levels and standards. Furthermore, organization archive database 54 provides historical performance data 107 which relates to the past performance of a particular organization. The server, using the enhancement and formatting program 108, processes all of this data and generates the results 109. In this example, results 109 include reports and graphs which inform an organization about: (a) activity cost and composition; (b) activity efficiency metrics; (c) trending analysis; (d) portfolio optimization; (e) product overhead cost and composition; (f) product operating profitability; (g) department operating profitability; and (h) benchmarking analysis.

### B. Algorithms

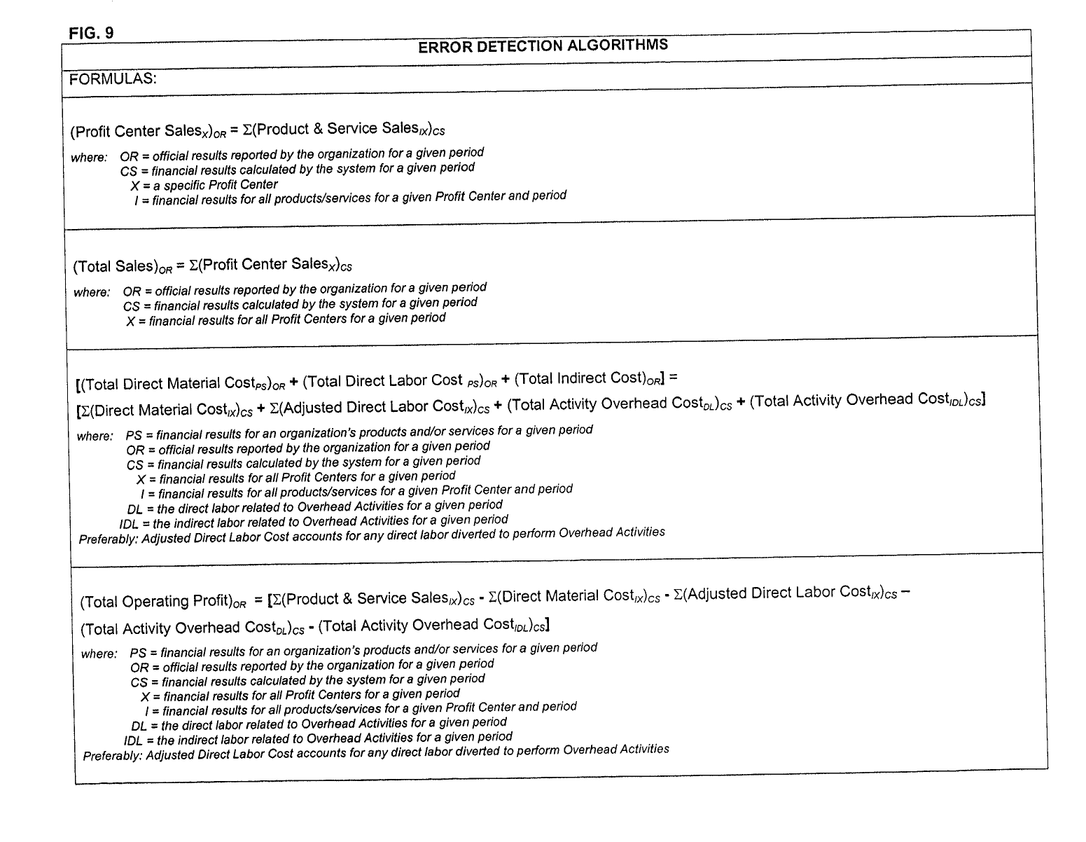

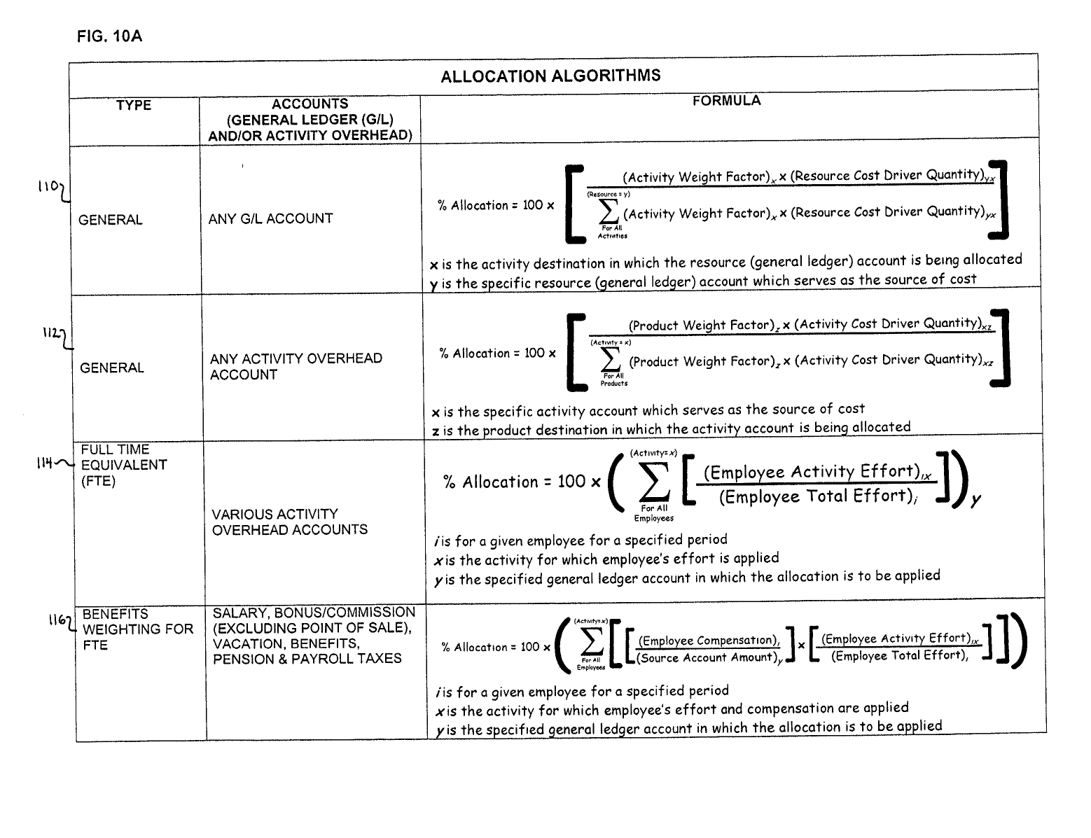

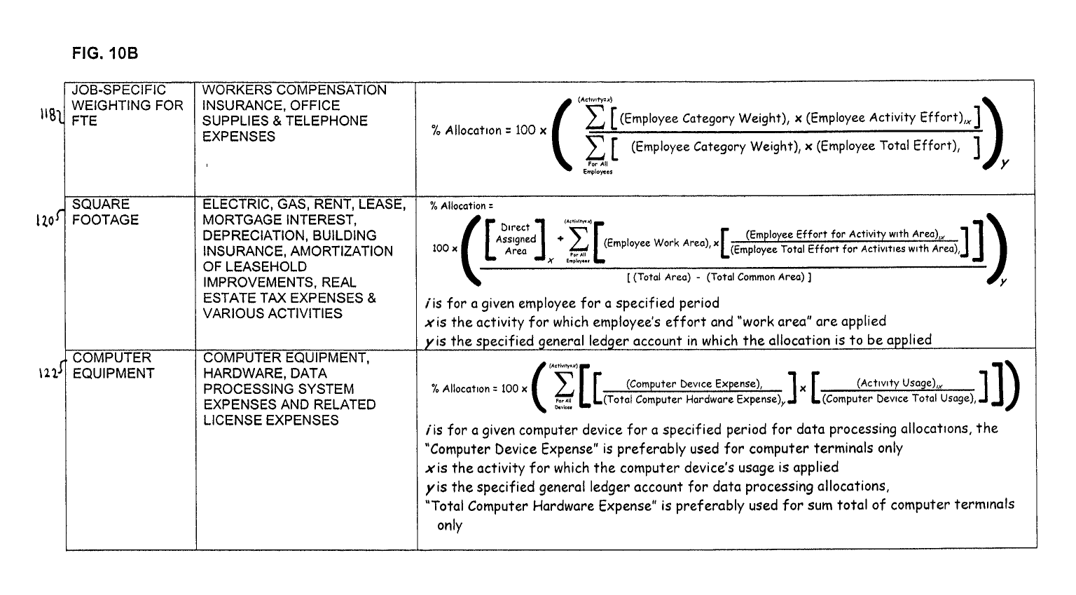

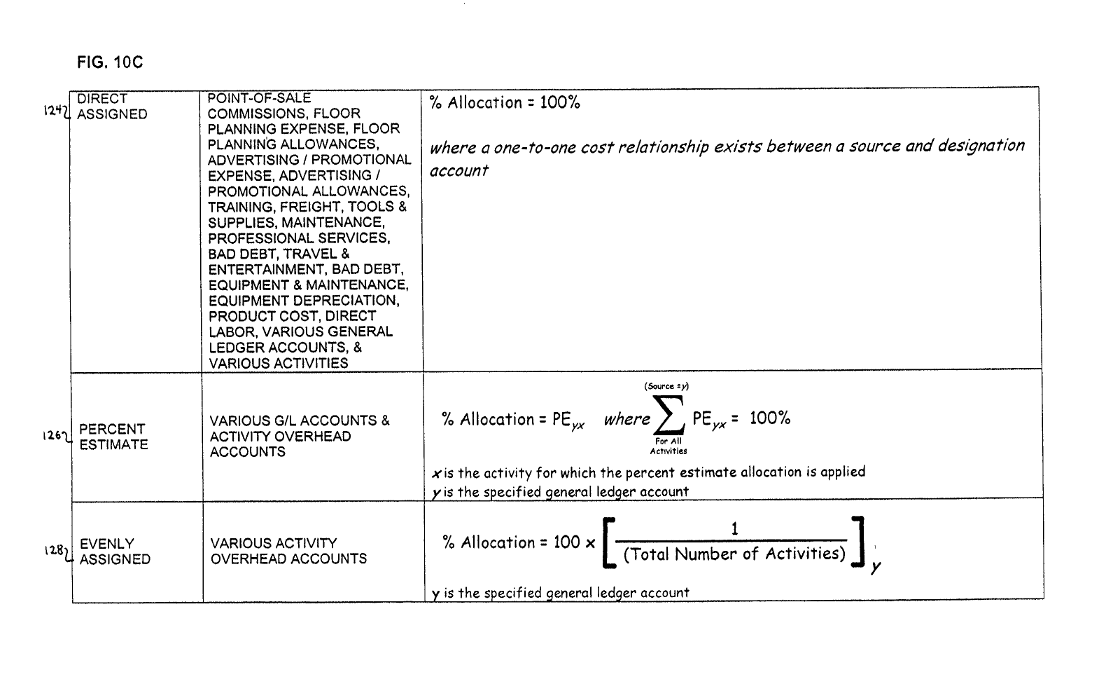

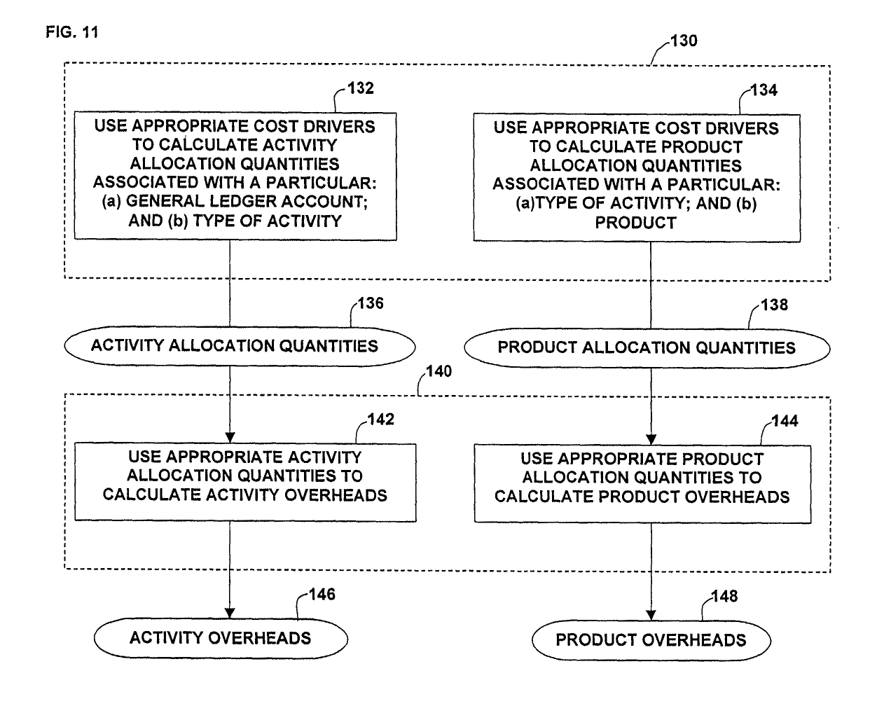

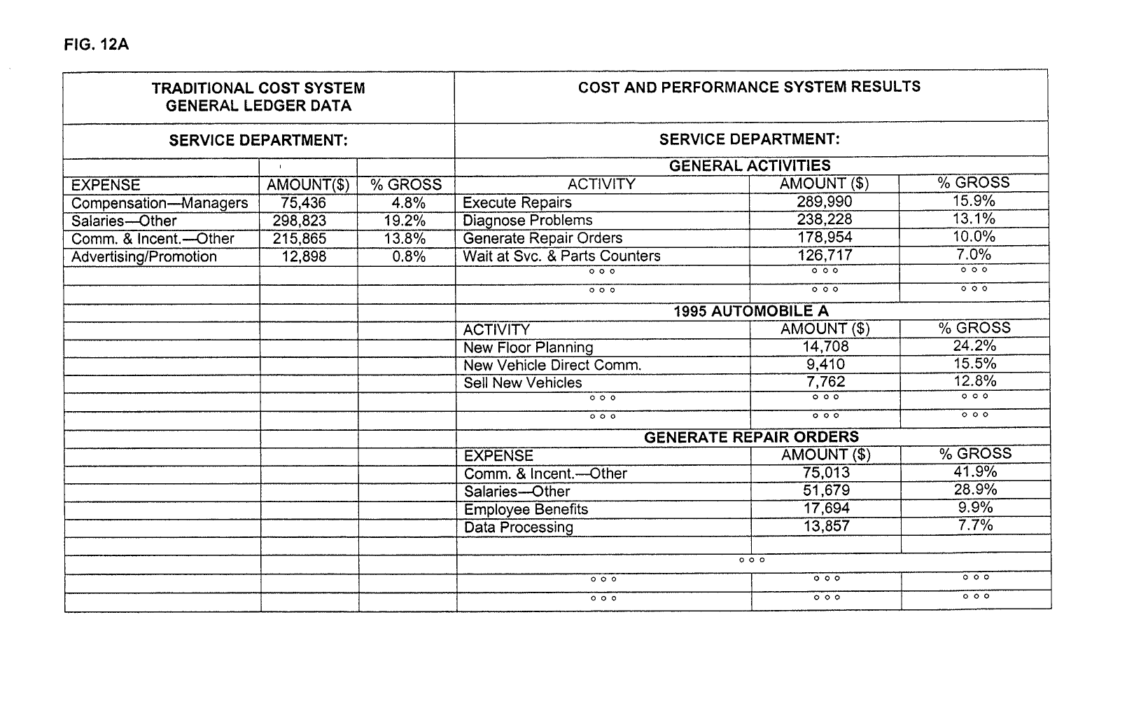

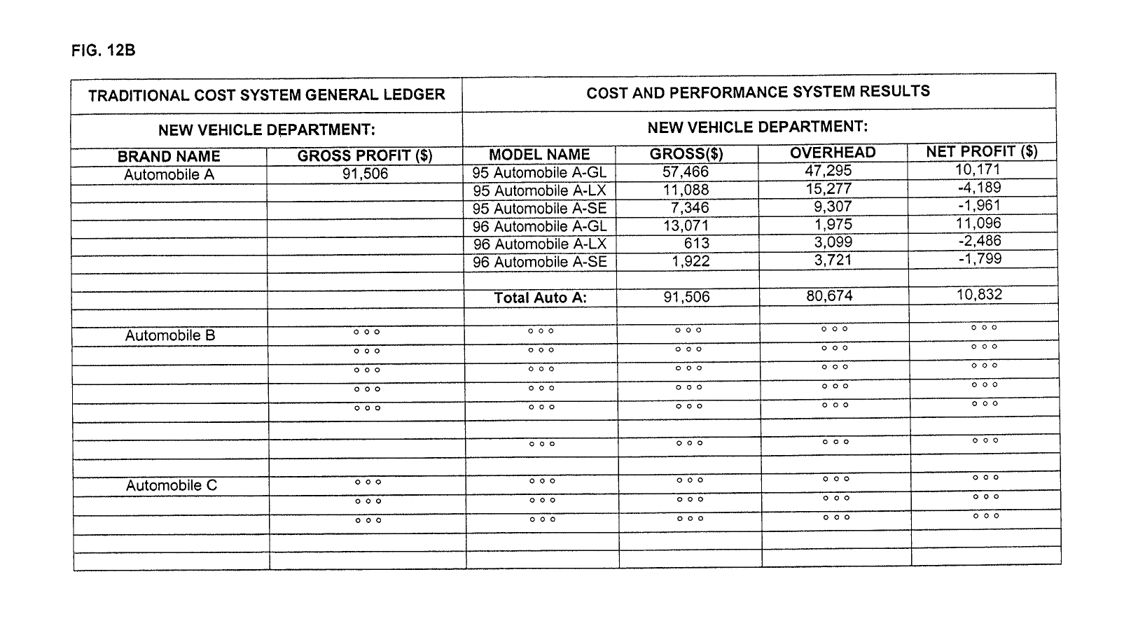

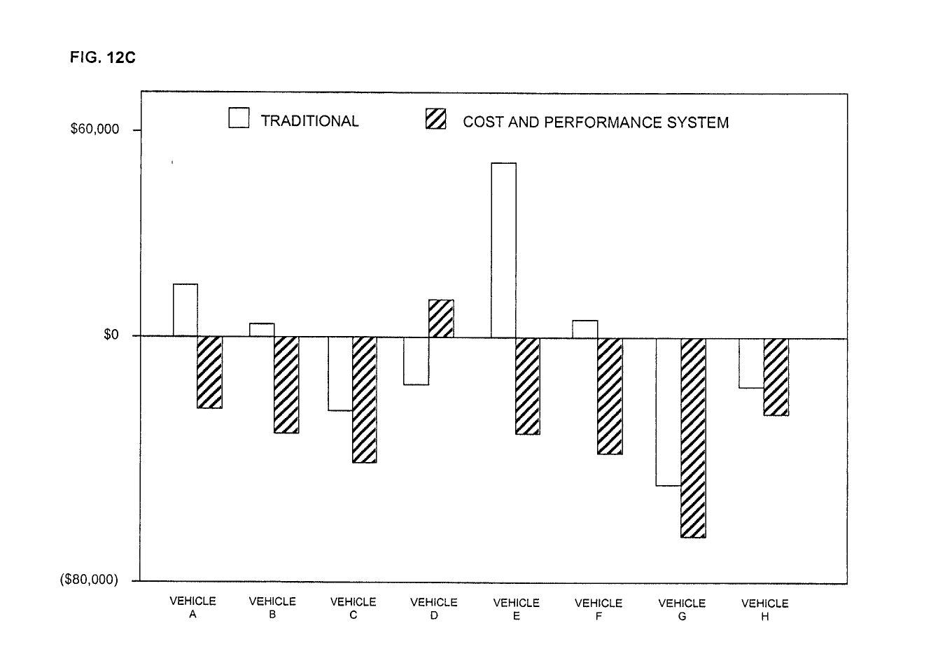

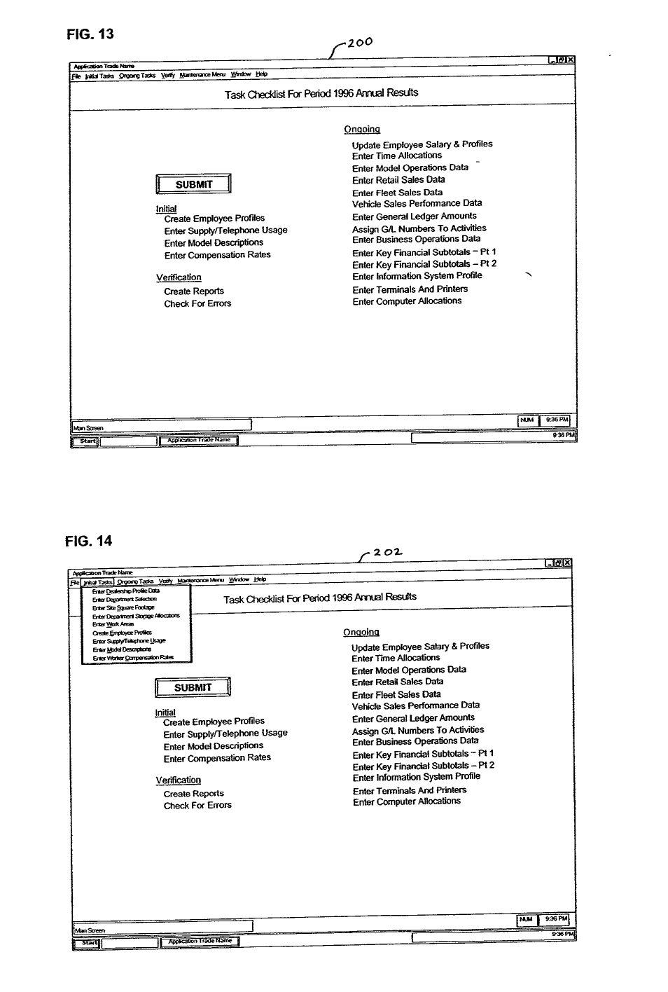

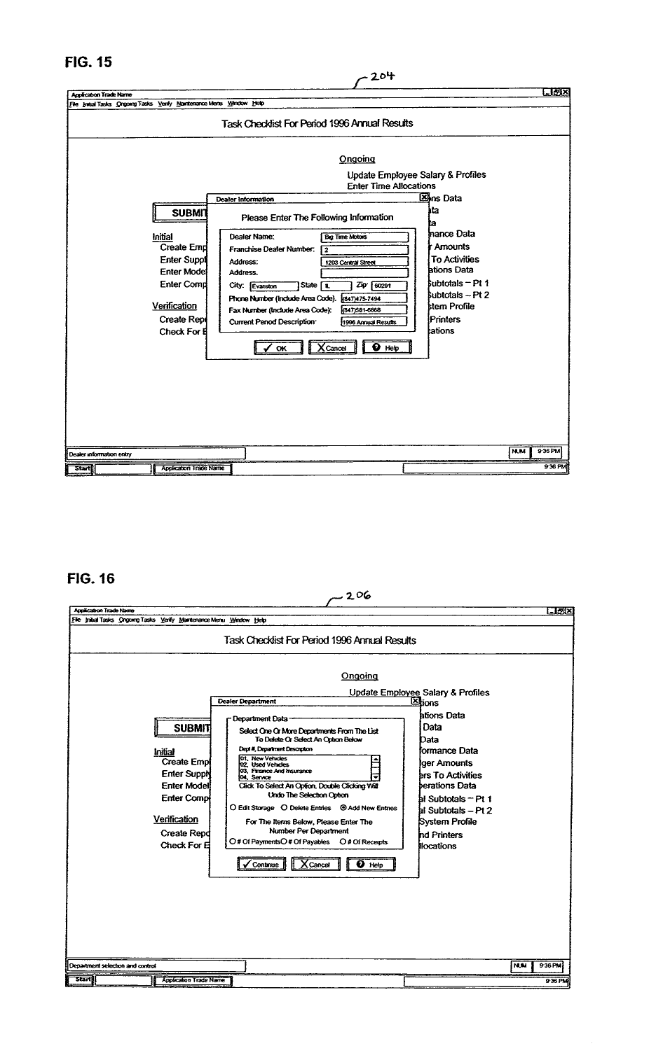

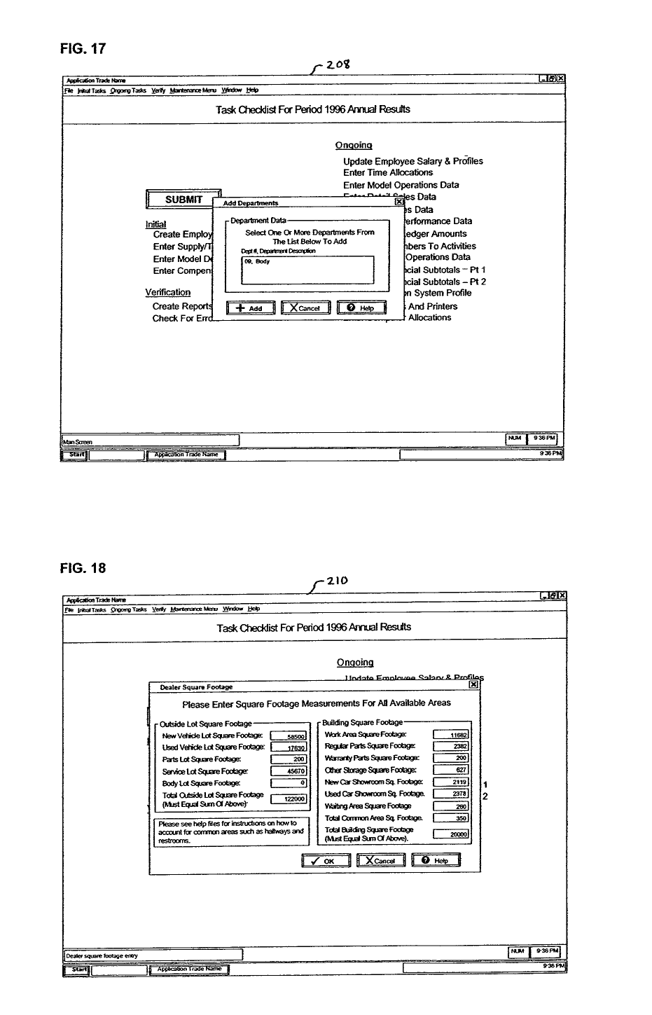

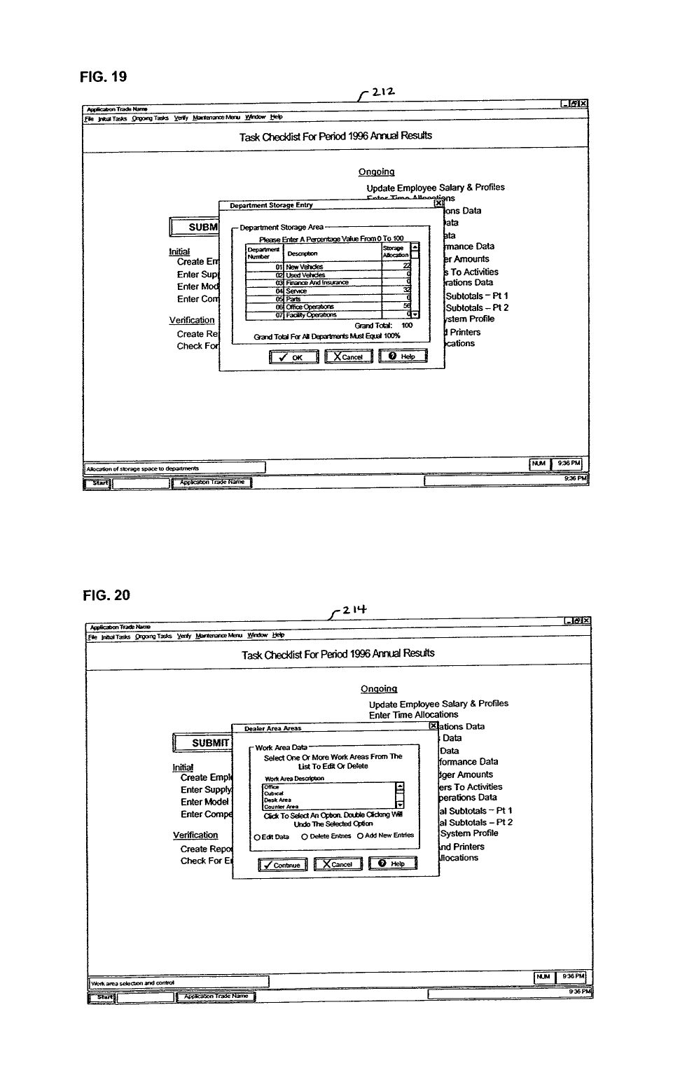

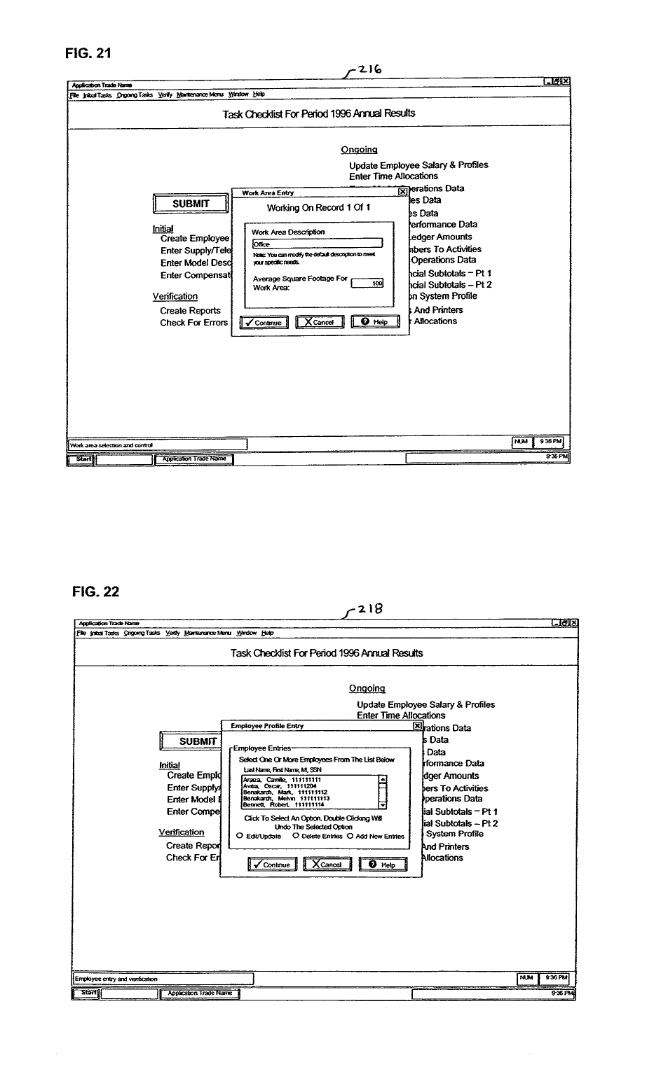

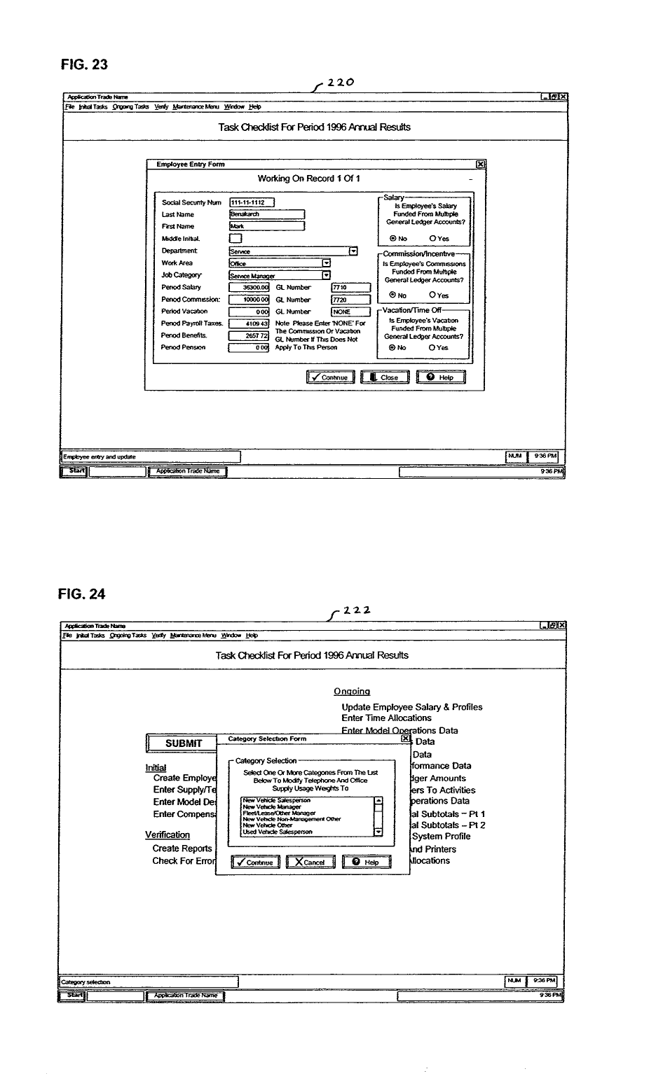

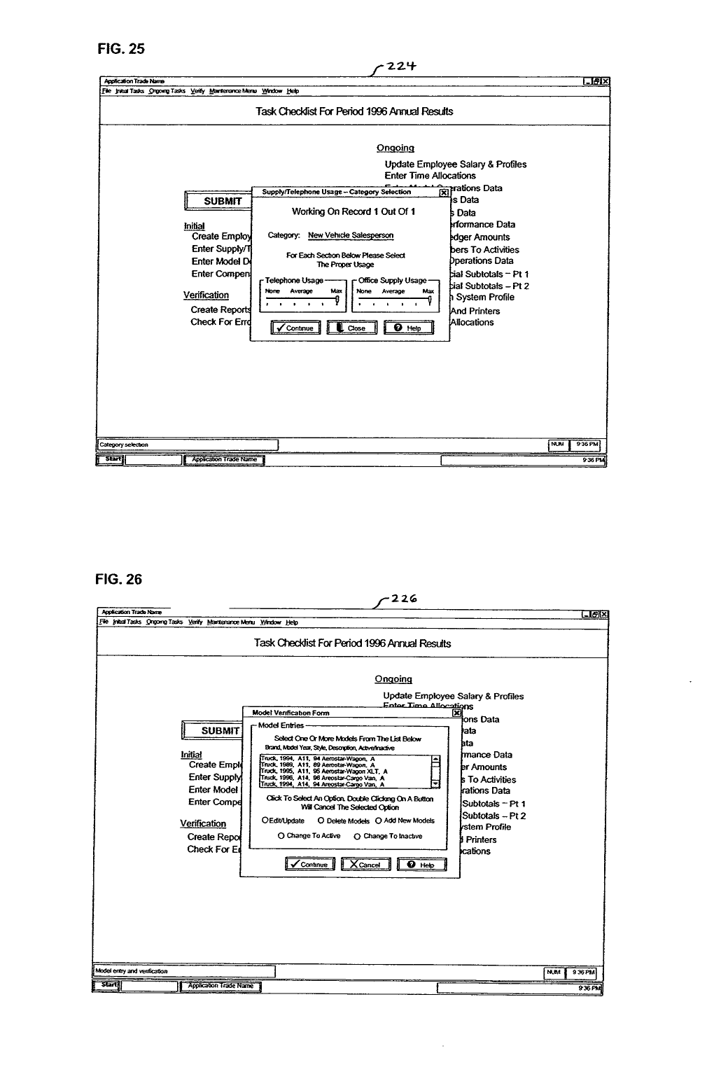

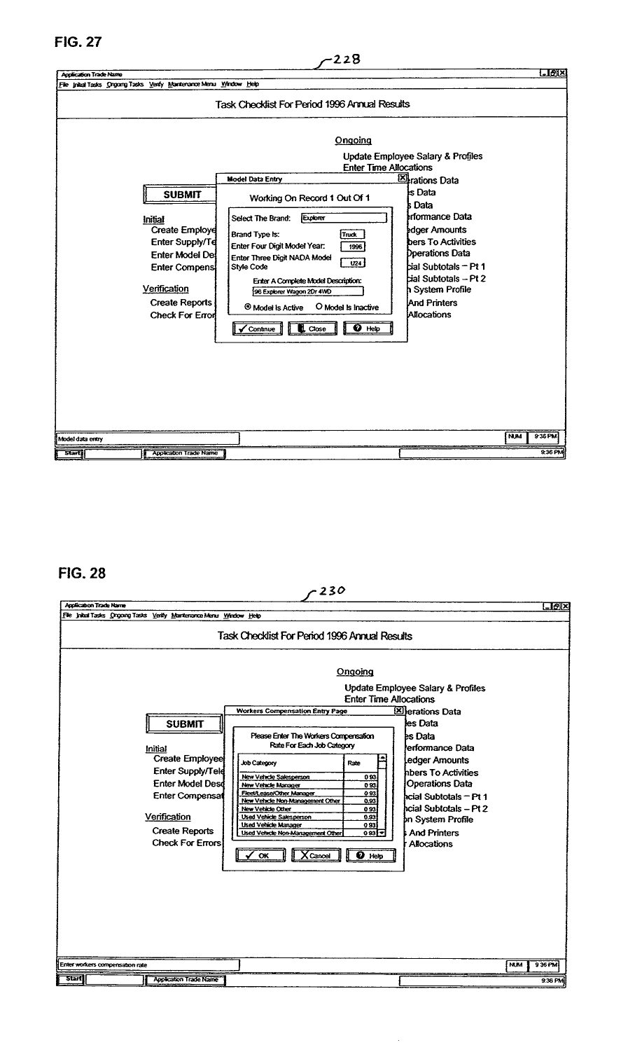

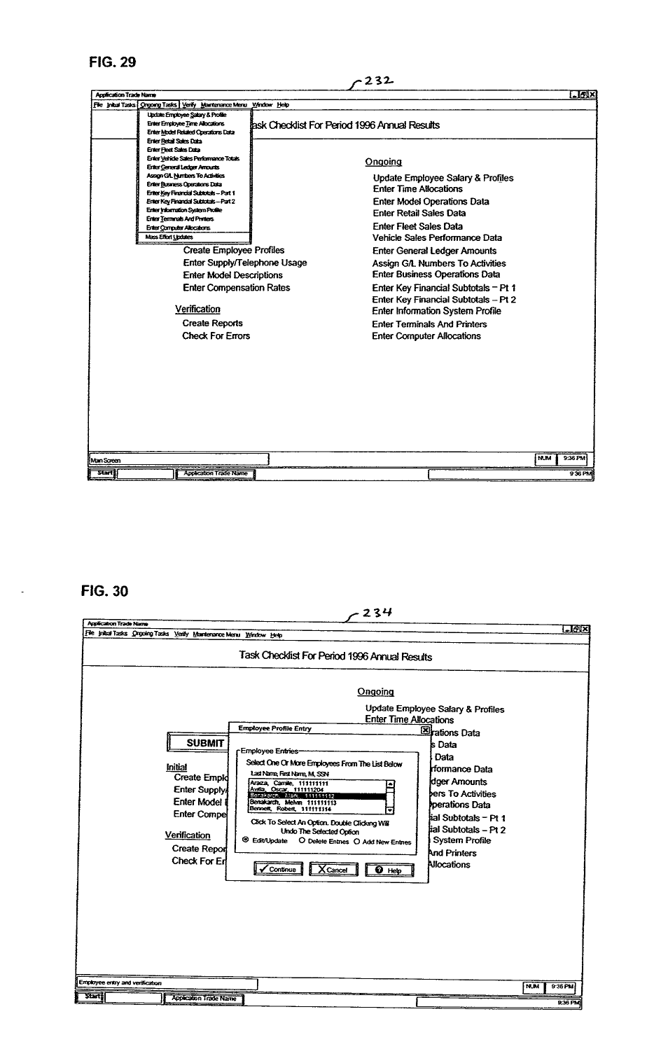

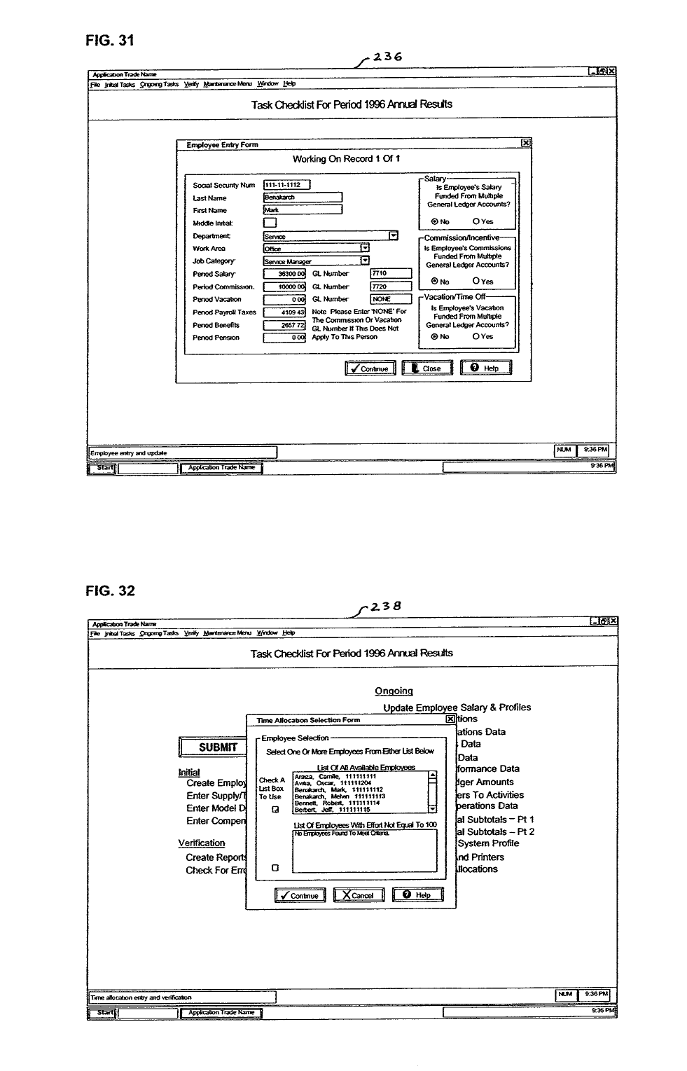

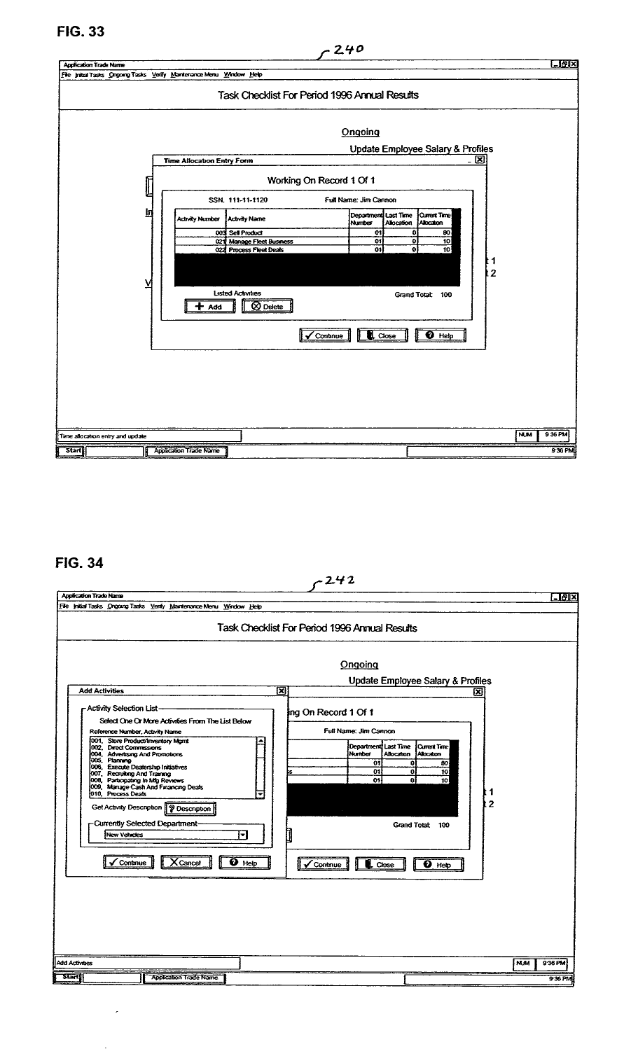

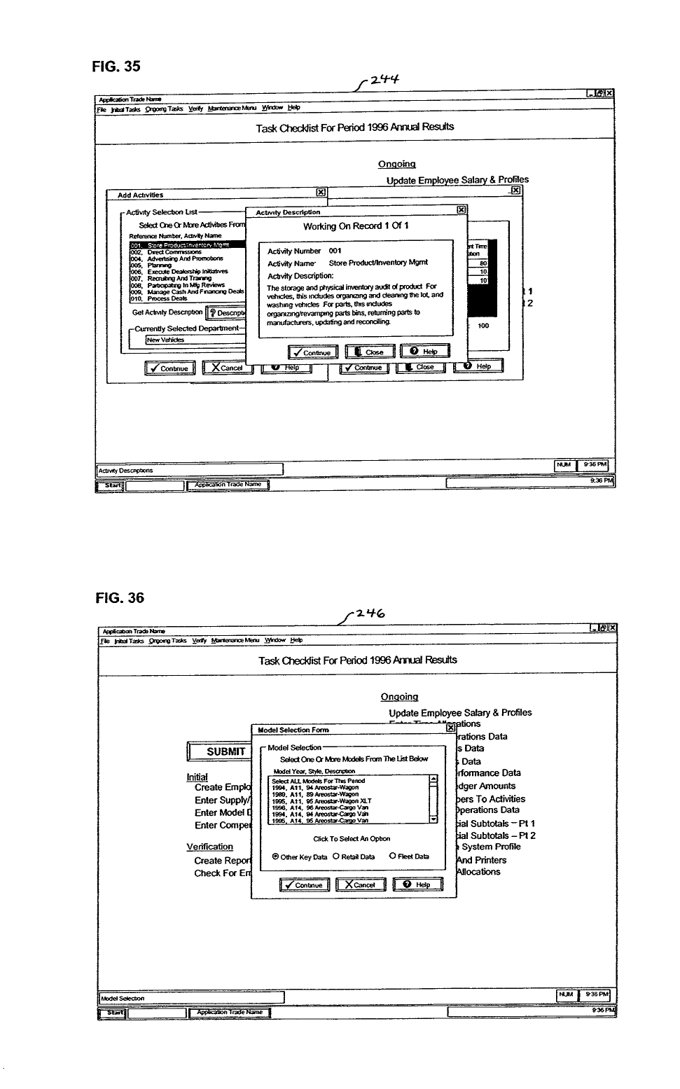

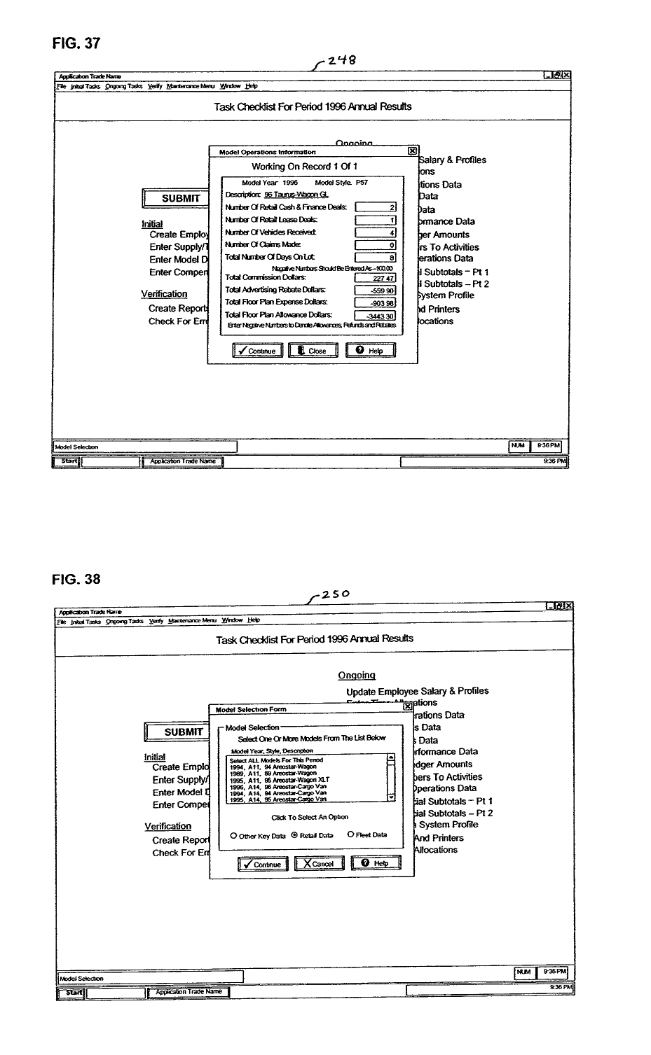

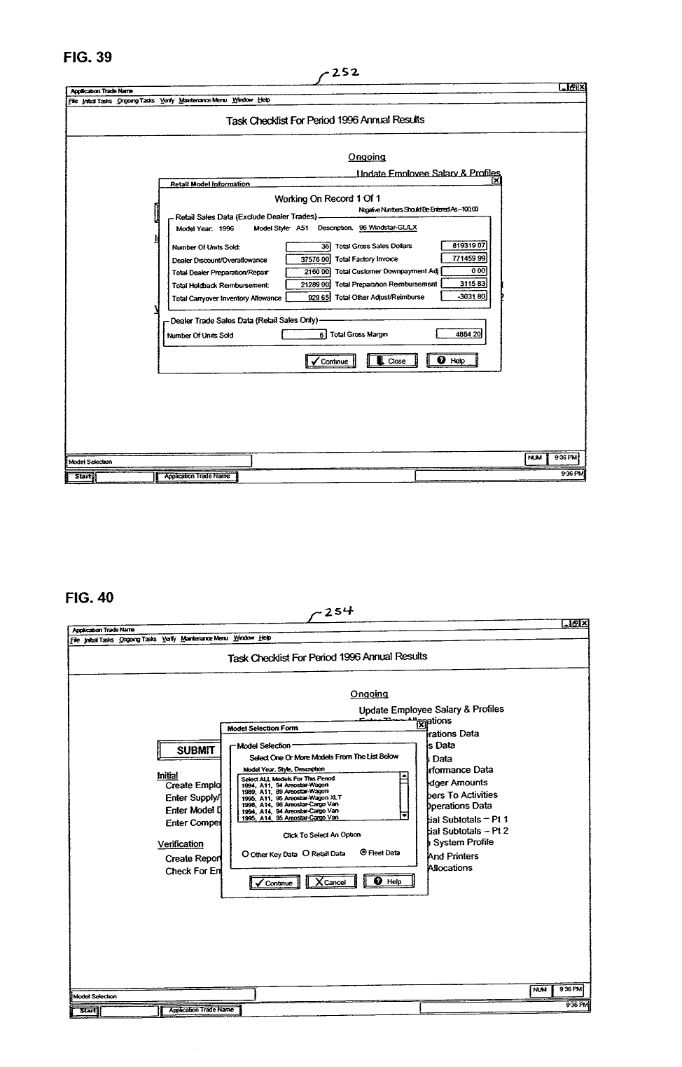

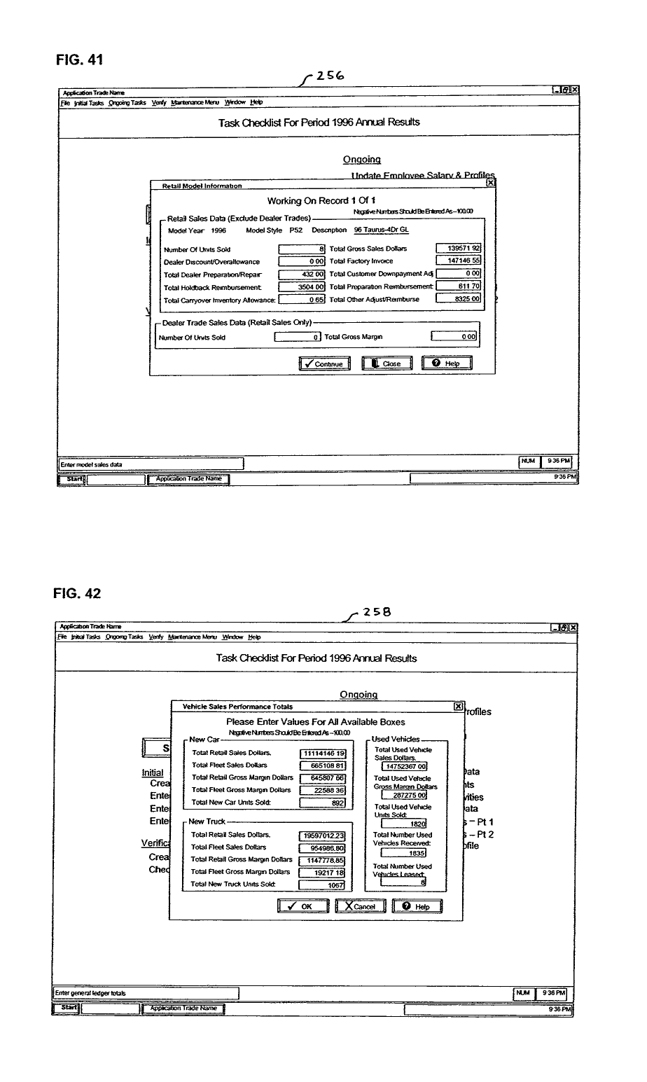

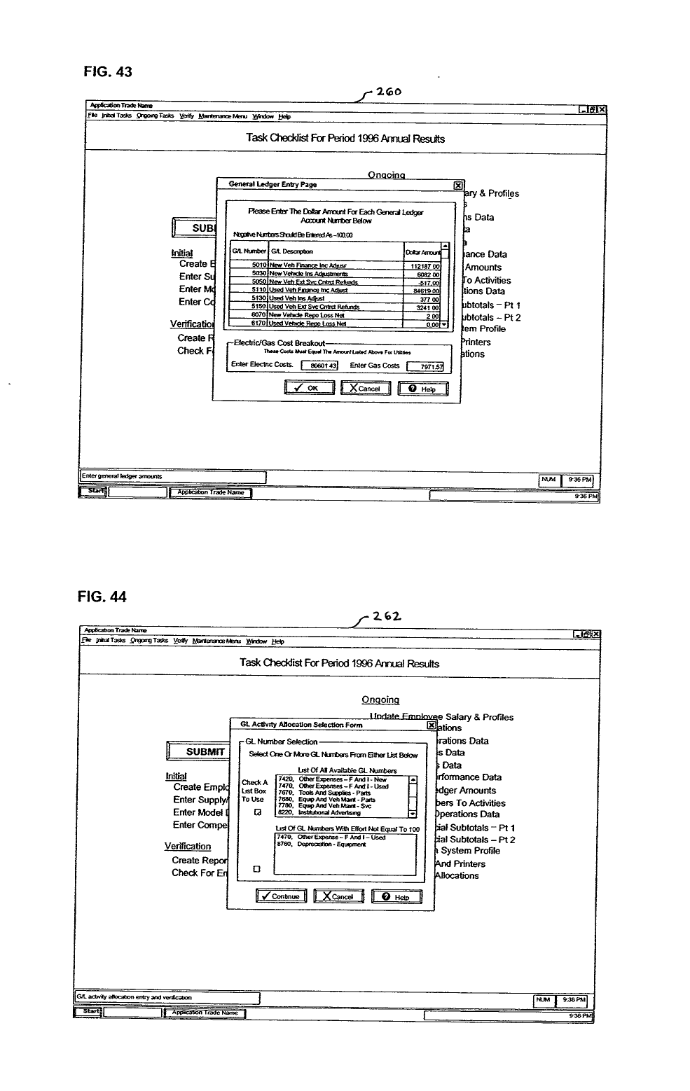

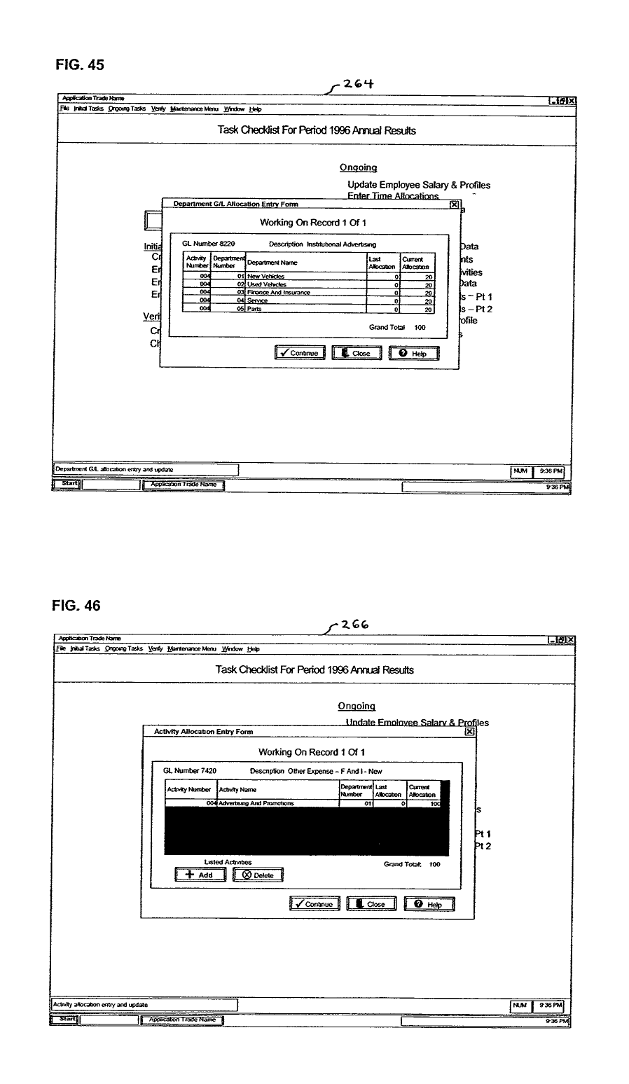

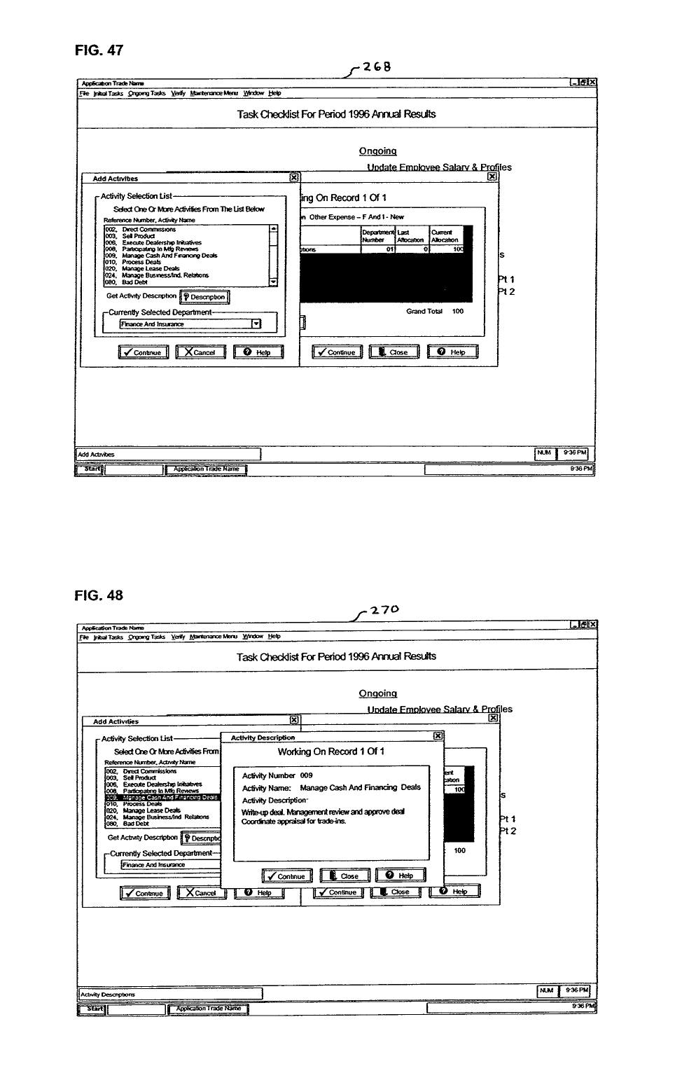

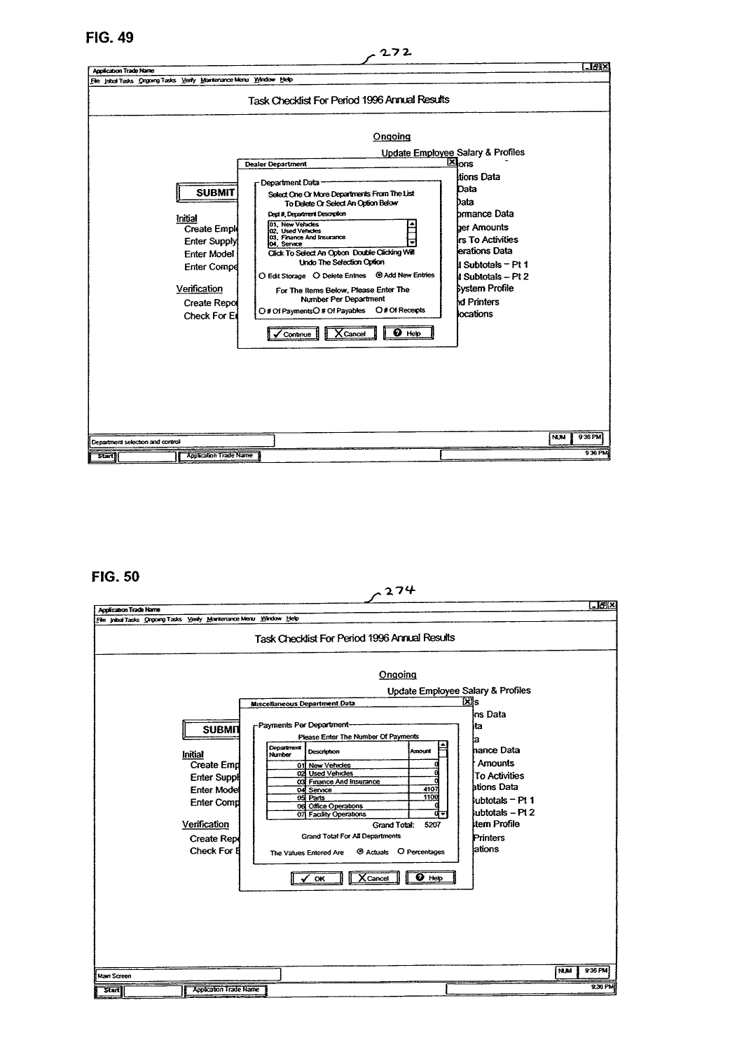

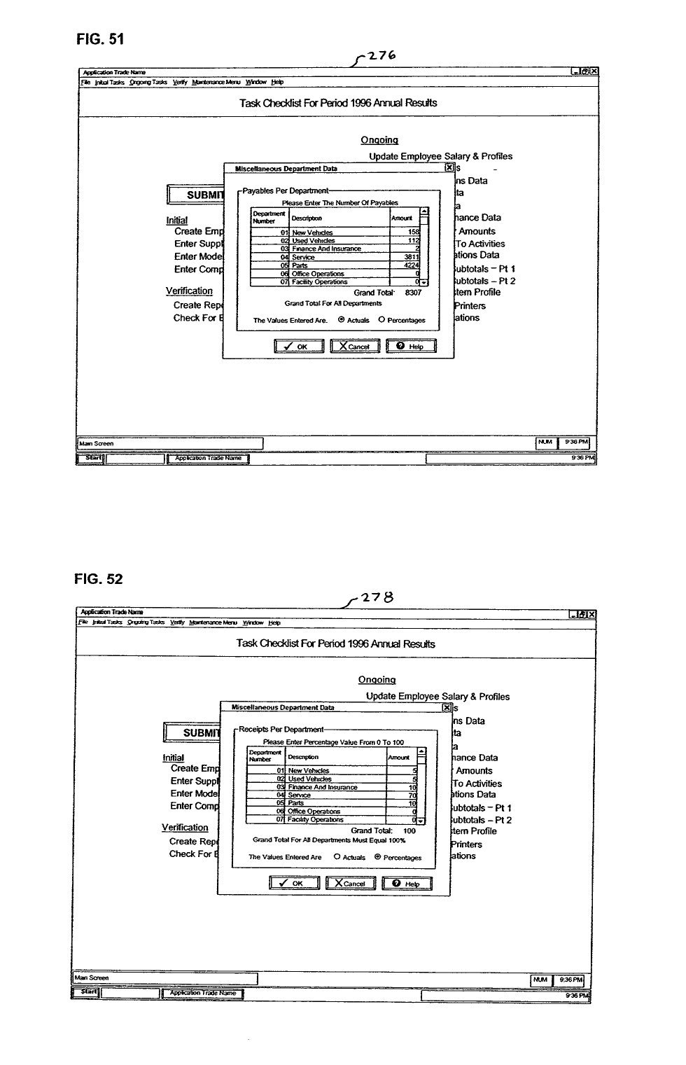

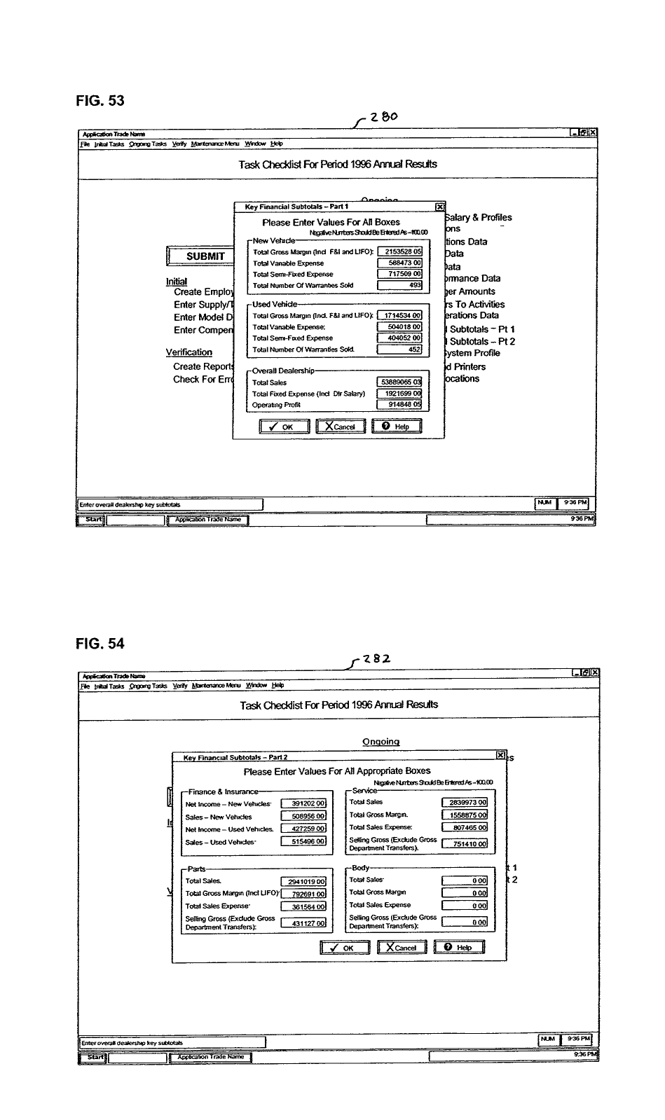

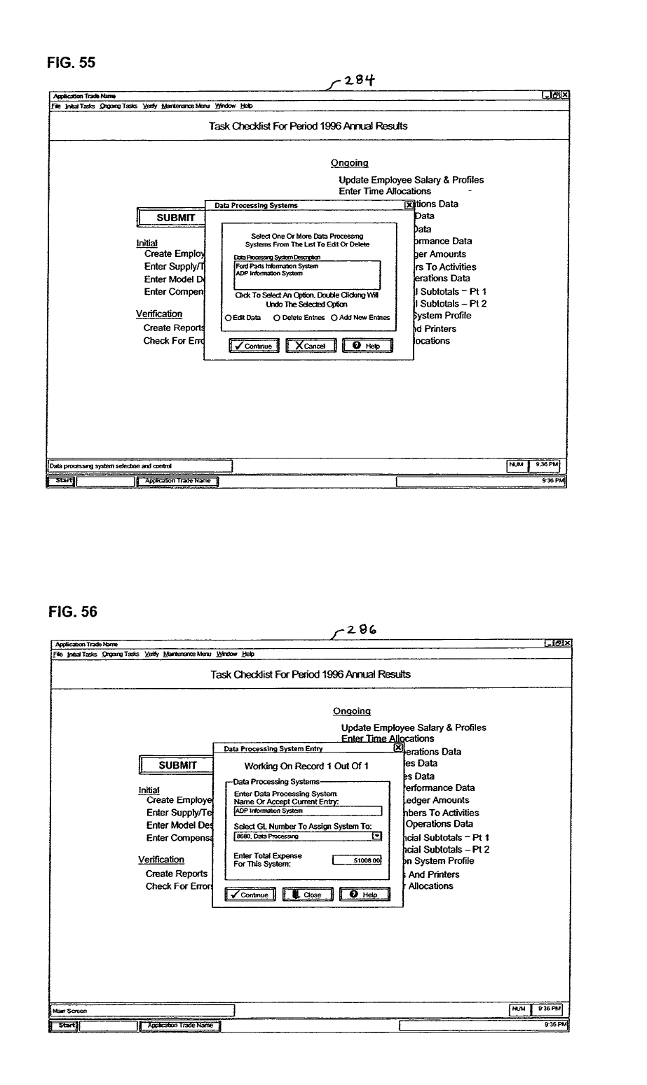

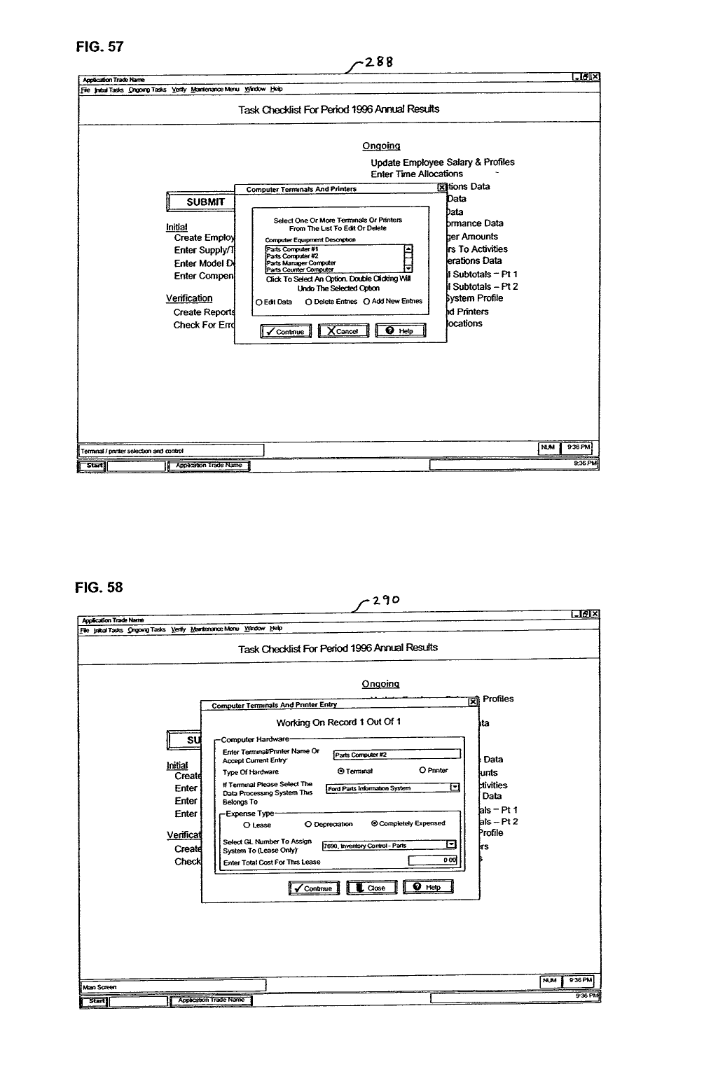

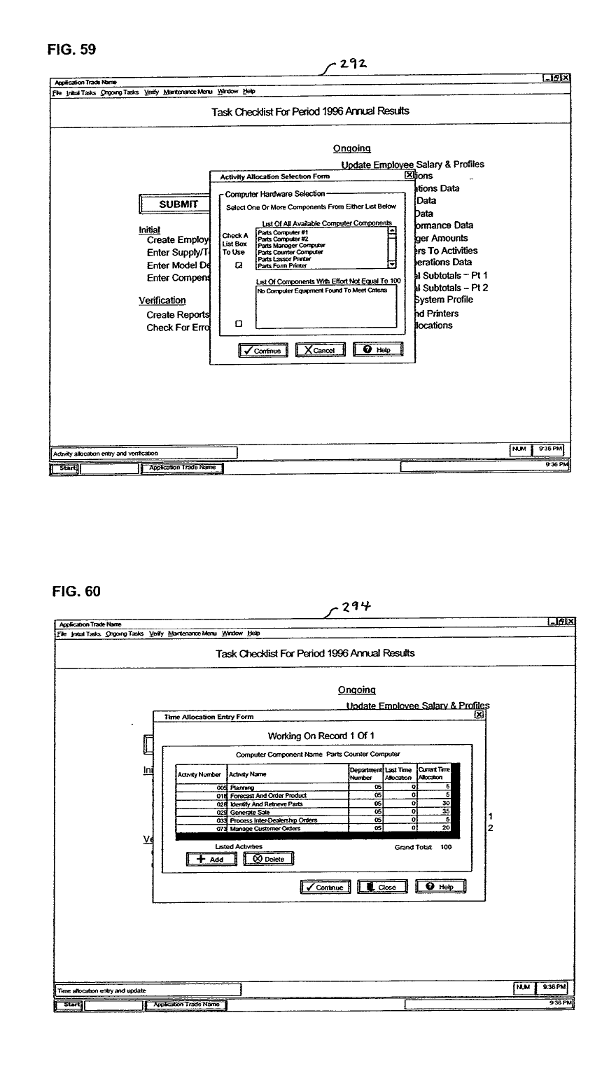

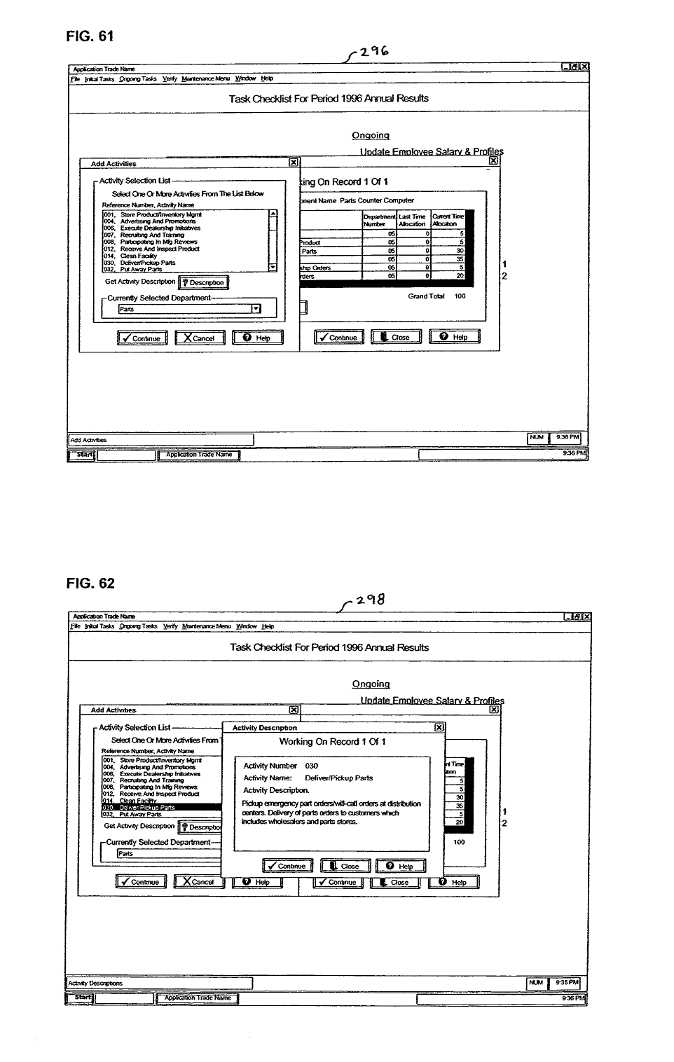

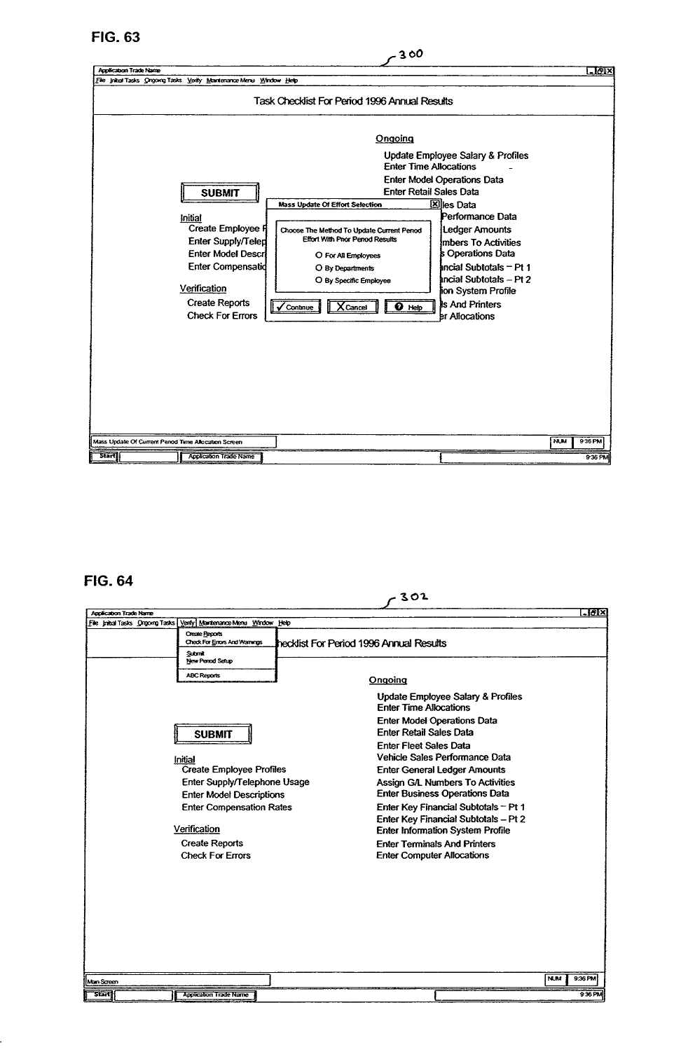

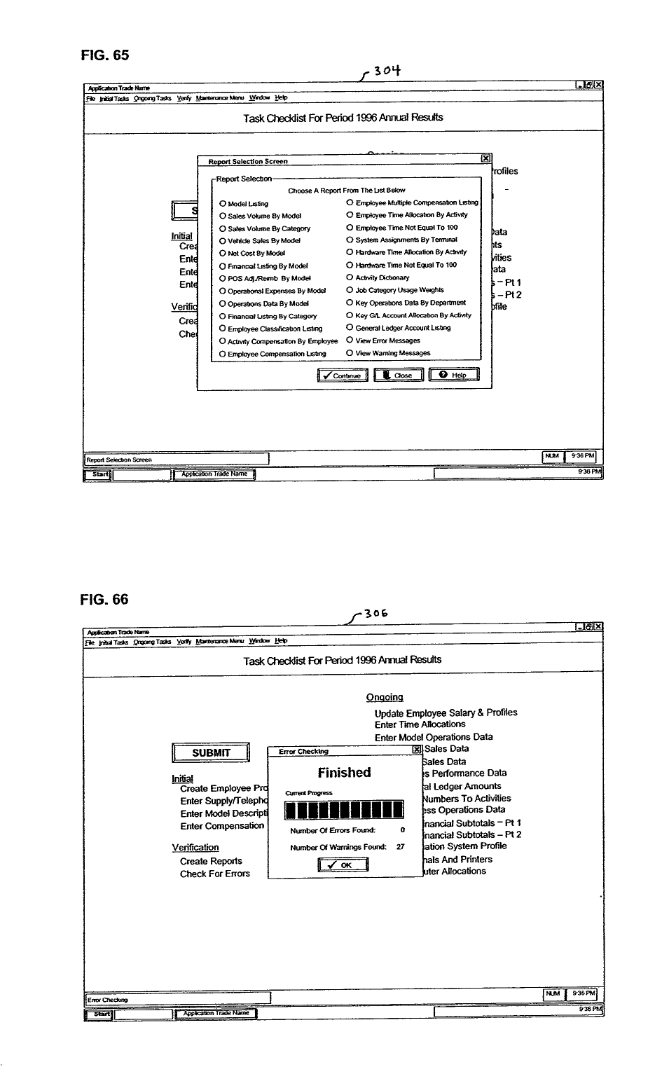

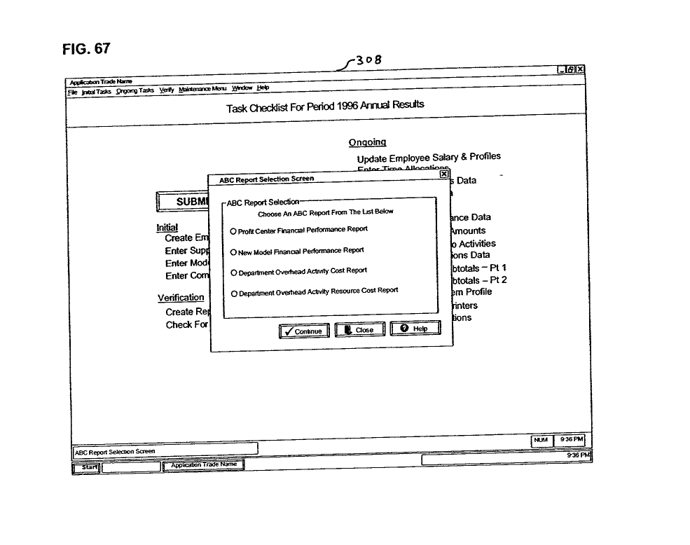

In one embodiment where the system collects user-specific data through interfaces, the receiving program 98 of the system includes a plurality of error detection algorithms which enable the server to detect when the user has made an erroneous entry. Functionally, these algorithms ensure that the cost data entered by the user in discreet form corresponds to the total data in the user's general ledger. In various embodiments, these algorithms are preferably represented by one or more of the four formulas provided in FIG. 9. In these formulas, the term profit center includes any portion or unit of a user (preferably an organization) which can generate revenue. An example of a profit center is a department within an organization. The term results includes information generated by or for a user (preferably, an organization). An example of a result is a financial statement which a subset of an organization provides to the organization. It should be appreciated that the algorithms represented in FIG. 9 can be used for any user in any industry. In addition, those algorithms can be modified for particular users or a particular type or category of user.

In a preferred embodiment, the input conversion program 100 of the system includes a plurality of algorithms for allocating general ledger accounts to activities and for allocating activity overheads to cost objects, such as activities, products, services and customers. These allocation algorithms incorporate cost drivers to accomplish this allocation. Certain allocation algorithms incorporate weight factors as well as cost drivers to compensate for atypical activities, scenarios or data. In one embodiment illustrated in FIGS. 10A through 10C, the input conversion program includes ten different types of allocation algorithms. Algorithm 110 is of a general type which can be used for any general ledger account. This algorithm is preferably represented by the formula provided in FIG. 10A. This formula includes an activity weight factor and a resource cost driver quantity. The activity weight factor includes any weight factor related to any activity. The resource cost driver quantity includes any numeric quantity or data which rationally relates to the consumption of one or more resources.

Algorithm 112 is also of a general type and can be used for any activity overhead or account. This algorithm is preferably represented by the formula provided in FIG. 10A. Here, the product weight factor includes any weight factor related to any product. The activity cost driver quantity includes any numeric quantity or data which rationally relates to the consumption or use of any activity. Algorithm 114 is of the full-time equivalency type, and this algorithm can be used for various activity overheads or accounts. Algorithm 114 is preferably represented by the formula provided in FIG. 10A. Here, employee activity effort includes data which represents the amount of effort a particular employee puts forth for a particular activity. The employee total effort includes data which represents all efforts put forth by a particular employee within the scope of the employment. Preferably, the employee activity effort includes the amount of time a particular employee spends on a particular activity, and the employee total effort includes the total amount of time a particular employee spends working for an organization.

Allocation algorithm 116 is of the full-time equivalency type. Algorithm 116 is preferably used for the general ledger accounts provided in FIG. 10A, and this algorithm is preferably represented by the formula provided in FIG. 10A. In this formula, employee compensation includes any data which relates to a particular employee's compensation. A source account amount includes data which relates to all compensation paid to all employees of an organization. The terms “employee activity effort” and “employee total effort” have the same meanings described above for algorithm 114.

Turning to FIG. 10B, allocation algorithm 118 is of the type which relates to job-specific weighting for full-time equivalency. This algorithm can be used for the general ledger accounts provided in FIG. 10B, and is preferably represented by the formula provided in FIG. 10B. Here, employee category weight includes any factor or data which serves to compensate for differences in the nature of employees or employee activities. The terms “employee activity effort” and “employee total effort” will have the same meanings as provided above for algorithm 114. Allocation algorithm 120 is of the square footage type which can be used for the general ledger accounts provided in FIG. 10B. Algorithm 120 is preferably represented by the formula provided in FIG. 10B. Here, employee work area includes the data which relates to the amount of area which an employee occupies while working. The employee effort for activity with area includes data which represents the amount of effort a particular employee puts forth for a particular activity in a particular area. The employee total effort for activities with area includes all effort put forth by all employees for all activities in all areas of an organization. The total area includes the total area of an organization which can be occupied by particular employees. The total common area includes the total area of an organization which is typically occupied by or designed to be occupied by most or all employees at once or at different times.

To illustrate the meaning of these terms in a new vehicle sales example, direct assigned area may be the showroom area for selling new vehicles; employee work area may be a salesperson's office area; employee effort for activity with area may be the amount of effort a salesperson puts forth for selling new vehicles while in his/her office; employee total effort for activities with area may be the amount of effort the salesperson puts forth for all activities while in his/her office; the total area may include all floor space and exterior property area of the organization; and the total common area may include the cafeteria and hallways within the organization's building.

Algorithm 122, which is of the computer equipment type, can be used for general ledger accounts listed in FIG. 10B. This algorithm is preferably represented by the formula provided in FIG. 10B. Here, computer device expense includes all data related to the expense of computer devices. Total computer hardware expense includes any and all data related to the expense of computer hardware. Activity usage includes data related to the usage of a computer device. Computer device total usage includes data related to the usage of a particular computer device for any and all activities. Preferably, the activity usage and computer device total usage include time spent using a computer device.

Allocation algorithm 124 is of the direct assigned type and can be used for the general ledger accounts listed in FIG. 10C. This algorithm is preferably represented by the formula provided in FIG. 10C. Allocation algorithm 126 is of the percent estimate type and can be used for various general ledger accounts and activities. This algorithm is preferably represented by the formula provided in FIG. 10C. Allocation algorithm 128 is of the evenly assigned type and can be used for various activities. This algorithm is preferably represented by the formula provided in FIG. 10C. In a preferred embodiment, algorithm 128 is of the cost-of-doing business type.

### C. Model Builder

In one embodiment of the present invention, the system's cost program is a model builder program, preferably an activity-based and query-based program enabling selective retrieval of data from one or more database models. Preferably, the model builder program is a commercially available activity-based program known as ABC Oros by ABC Technologies, Inc. FIG. 11 illustrates the function of and relationship between the input conversion program and the activity-based program in one embodiment of the present invention. The function of the input conversion program, as indicated by blocks 130, 132 and 134, results in activity allocation quantities and product allocation quantities, as indicated by ovals 136 and 138. Preferably, the input conversion program uses the appropriate cost drivers to calculate activity allocation quantities and product allocation quantities which are associated with the relationship between a particular general ledger account and a particular type of activity, and the relationship between a particular type of activity and a particular type of product, service or customer, respectively. As indicated by blocks 140, 142 and 144 the model builder program uses the appropriate activity allocation quantities and product allocation quantities to calculate activity overheads and product overheads as indicated by ovals 146 and 148. The server then uses these activity overheads and product overheads to ultimately provide activity based results to the user.

### IV. User Operation

In one embodiment of the present invention, the user can open an account with the implementor of the system by logging onto the internet and hyperlinking to the system website. Preferably, the website will include an electronic procedure which the user can follow to open an account. Alternatively, the user can request that a representative of the system implementor personally visit the user's site to arrange for the opening of an account. It is preferable that the system implementor provides the user with a username, password and other security tools to maintain the confidentiality and security of the user's on-line account.

Preferably the system includes the standard activity data necessary to accommodate the user before the user opens an account. However, if the system does not include such activity data at such time, the system implementor can acquire such data or generate such data on behalf of the user. With the system including the activity data associated with the user, preferably the user can upload the user's raw financial data from the user's on-site database to a system website account designated specifically for that user. After uploading the user's raw data, the system will enable the user to access a plurality of interfaces. The interfaces will prompt the user to input certain user-specific data not included in the general ledger, such as certain activity data or operational information and certain financial data. As the user enters this data, the system will perform error checks to ensure that the data entered by the user corresponds to the raw general ledger. If the system detects an error, the system will notify the user, preferably with an error message, prompting the user to repeat one or more entries.

After the user has entered the data through the interfaces, the system will use the system programs to manipulate this data and process this data and provide the user with results. Preferably, after the user has entered the data through the interfaces, the system will provide the user with results within approximately one to ten minutes, depending upon the amount of data being processed. The user will then be able to access these results at will, in real time. When accessing the results, it is preferable that the system website includes a plurality of options which enable the user to view the results in different forms, such as graphs, reports and charts. It should be appreciated that the system can be adapted to provide the user with suggested courses of actions in the areas of business planning, strategy, opportunity, taxes and other useful areas.

The system also enables the user to update the results form time to time. For example, if a user desires to provide new data through the interfaces, the system will generate new results. The system will also enable the user to obtain continued support for the user's cost system. In providing this support, the system will automatically periodically communicate with the user's on-site database and retrieve new data, and use this data to generate new results. The system preferably will provide updated results in this manner on a monthly, quarterly, annual or other periodic basis. The system can also be adapted to periodically poll the user or an organization for certain types of changes, such as changes in employee efforts allocations or computer software and hardware usage. The system can perform such polling by distributing surveys to the user in electronic form or paper form and requesting the user to complete these forms. If the forms are electronic, the system can automatically enter the new data presented in these forms into the system's databases. Preferably, this polling will enable the system to maintain current activity data for a particular user type or a particular user.

In addition, the system can provide the user with benchmarking data. In accordance with the appropriate licenses obtained by users and third parties, the system can make available to users certain user-specific data and activity data. For example, the system can provide a user with general industry statistics or data, or the system can provide a user with specific statistics regarding a particular industry or a particular type of business, company or organization, or certain data regarding a particular business, company or organization.

### V. Results

As described earlier, the system can provide users with a variety of results which include cost and performance information. The cost and performance information or results provided by the system provide users with a greater degree of accuracy and detail than the information provided by traditional cost systems. In one embodiment illustrated in FIG. 12A, the traditional cost system provides general cost information to the user regarding service department expenses. When this raw data is entered into the system, the system of the present invention provides the results illustrated in FIG. 12A. In this embodiment, the results included an itemization of the service department expenses into the following areas: (a) service department activities; (b) activities regarding a particular vehicle; and (c) expenses regarding general repair orders. Moreover, the results included a cost corresponding to each item in each of these areas. This embodiment illustrates the level of detailed results which the system can provide.

As illustrated in FIG. 12B, the traditional cost system general ledger provides general cost information regarding a new vehicle department in one embodiment of the present invention. The system, using this raw data, provides the user with detailed results regarding each vehicle brand and model within the new vehicle department, as illustrated in FIG. 12B.

Furthermore, a comparison of the system results to traditional cost system results can reveal significant inaccuracies and distortions which a traditional cost system provides to users. As illustrated in FIG. 12C, the traditional cost system results and the results of the system can vary to a relatively significant degree. Specifically, in this example, for vehicles A, B, E and F, the traditional system informed the organization that these vehicles were profitable while the system of the present invention informed the organization that these vehicles were not profitable. In addition, for vehicle D, the traditional system informed the organization that this product was not profitable while the system of the present invention informed the organization that this product was profitable.

### VI. Interfaces

Though the system preferably obtains user-specific raw general ledger data by automatically transferring or uploading it to the system's database, in one embodiment the system can use a plurality of screens or graphical user interfaces to acquire such general ledger data and other data from the user. It should be appreciated that the system can receive user-specific data in part automatically and in part manually through interfaces. One example of these interfaces is illustrated in FIGS. 13 through 67. As illustrated in FIG. 13, interface 200 is the primary screen of the system. From this screen, the user can access three key menus for modeling the user's operations, including initial tasks, ongoing tasks and verification. As illustrated in FIG. 14, with interface 202 the user can enter fundamental information. With the exception of employee profiles and model information, this data will seldom need updating from period to period. As illustrated in FIG. 15, interface 204 captures the users address, key telephone numbers and description of the period being analyzed.

As illustrated in FIG. 16, interface 206 deactivates the user's departments already selected or begins the process of activating the user's departments not yet selected. As illustrated in FIG. 17, interface 208 prompts the user for the data which the system requires to activate the user departments. As illustrated in FIG. 18, interface 210 enables the system to capture the square footage for key building and lot areas. As illustrated in FIG. 19, interface 212 enables the system to capture the percentages for allocating “other storage area” among user departments. As illustrated in FIG. 20, interface 214 enables the system to capture the predefined employee work areas.

As illustrated in FIG. 21, interface 216 enables the system to capture the average square footage for selected employee areas. As illustrated in FIG. 22, interface 218 enables the system to initiate the process for creating a new employee profile or selecting existing employees for editing their profiles. As illustrated in FIG. 23, interface 220 enables the user to edit the profile of an existing employee, or use a blank profile screen to create a new employee profile. The system uses this interface 220 to capture the information for each employee, including general ledger accounts in which their salaries and benefits are paid, and job category.

As illustrated in FIG. 24, interface 222 enables the user to select the job categories for defining the office supply and telephone average usage of the user's employees. As illustrated in FIG. 25, interface 224 enables the system to capture the office supply and telephone average usage for active job categories. As illustrated in FIG. 26, interface 226 enables the user to add new product models or update existing product models. This interface also enables the user to delete existing product models or change the “offering” status of the product models from active to inactive or vice versa. As illustrated in FIG. 27, interface 228 enables the system to capture the product model description information required for adding a new product model to the user's portfolio or editing the product model description information of existing models.

As illustrated in FIG. 28, interface 230 enables the system to capture the worker compensation rates for each active job category. As illustrated in FIG. 29, interface 232 enables the user to enter financial and operational information. The system enables the user to update this data from period to period. As illustrated in FIG. 30, interface 234 enables the user to select employee profiles for editing. As illustrated in FIG. 31, interface 236 enables a user to edit employee salary and profiles. As illustrated in FIG. 32, interface 238 enables the user select employees for assigning their respective time allocations to activities performed by them in a given period.

As illustrated in FIG. 33, interface 240 displays the current employee time allocations by activity, and enables the user to edit existing employee time allocation profiles or initiate the process for adding activities to the employee's time allocation profile. As illustrated in FIG. 34, interface 242 enables the user to select the activities to be added to the employee's time allocation profile. This interface also enables the user to select activities outside the given employee's designated department. As illustrated in FIG. 35, interface 244 displays the definition of activities in question. As illustrated in FIG. 36, interface 246 enables the user to select product models for adding or editing respective operational data.

As illustrated in FIG. 37, interface 248 enables the system to capture the operational data for product models and enables the user to edit the information for existing product models. As illustrated in FIG. 38, interface 250 enables the user to select product models for adding or editing respective retail sales data. As illustrated in FIG. 39, interface 252 enables the system to capture the retail sales data for product models and edits the information for existing product models. As illustrated in FIG. 40, interface 254 enables the user to select product models for adding or editing respective fleet sales data. As illustrated in FIG. 41, interface 256 enables the system to capture the fleet sales data for product models and enables the user to edit the information for existing product models.

As illustrated in FIG. 42, interface 258 enables the system to capture key product sales data for both new and used product departments. As illustrated in FIG. 43, interface 260 enables the system to capture the amounts for all active general ledger for a given period. This interface also breaks out or divides out the utility amount by gas and electric. As illustrated in FIG. 44, interface 262 enables the user to select general ledger accounts to be allocated to activities or departments and enables the user to edit existing general ledger account allocation profiles. As illustrated in FIG. 45, interface 264 enables the system to allocate specific general ledger accounts to departments.

As illustrated in FIG. 46, interface 266 enables the system to allocate specific general ledger accounts or activities and displays and edits allocation profiles of existing general ledger accounts. As illustrated in FIG. 47, interface 268 enables the user to select activities to be added to the general ledger account allocation profiles. As illustrated in FIG. 48, interface 270 displays the definition of activities in question. As illustrated in FIG. 49, interface 272 enables the user to initiate the process for capturing operational data related to the number of payments received (accounts receivables), number of payables (accounts payable) and the number of receipts processed. As illustrate in FIG. 50, interface 274 displays an allocation of the number of payments received (accounts receivable) among user departments on the basis of sales origin. This interface also provides the user with the option to use percentages. As illustrated in FIG. 51, interface 276 displays an allocation of the number of payables (accounts payable) among user departments on the basis of expense origin. This interface also enables the user to use percentages. As illustrated in FIG. 52, interface 278 displays an allocation of the number of receipts processed among user departments on the basis of sales origin. This interface also enables the user to use percentages.

As illustrated in FIG. 53, interface 280 enables the system to capture key departmental and enterprise financial totals. As illustrated in FIG. 53, interface 282 enables the system to capture key departmental financial totals. As illustrated in FIG. 55, interface 284 enables the user to initiate the process for adding new or editing/deleting existing information management system profiles. As illustrated in FIG. 56, interface 286 enables the system to capture new information management system profiles and also enables the user to edit existing ones.

As illustrated in FIG. 57, interface 288 enables the user to initiate the process for adding new or editing/deleting existing computer hardware profiles. As illustrated in FIG. 58, interface 290 enables the system to capture new computer hardware profiles and also enables the user to edit existing ones. As illustrated in FIG. 59, interface 292 enables the user to select computer hardware devices for assigning their respective time allocations to activities performed by them in a given period.

As illustrated in FIG. 60, interface 294 displays current computer hardware time allocations by activity and enables the user to edit existing computer hardware time allocation profiles or initiate the process for adding activities to the computer hardware's time allocation profile. As illustrated in FIG. 61, interface 296 enables the user to select activities to be added to the computer hardware's time allocation profile. As illustrated in FIG. 62, interface 298 displays the definition of activities in question. As illustrated in FIG. 63, interface 300 displays the status quo for multiple employee time allocation profiles simultaneously for a new period. This interface also enables the user to carry over employee time allocation profiles from the previous period to the current period, for all employees, by departments, or by specific employees.

As illustrated in FIG. 64, interface 302 enables the system to verify that the user has provided and entered accurate data. This interface also enables the user to retrieve the system's output or results. As illustrated in FIG. 65, interface 304 enables the user to obtain various reports, based upon the data entered, or identify errors. As illustrated in FIG. 66, interface 306 enables the system to check the data entered for accuracy and displays the number of errors and warnings found. Finally, as illustrated in FIG. 67, interface 308 enables the system to generate the analysis reports of the user's operations, certain samples of which are illustrated in this interface.

The cost and performance system of the present invention makes it practical and convenient for users to use a multi-driver cost system such as activity-based costing. The one or more servers of the system uses one or more system programs and preferably activity data to process a user's raw financial data, resulting in detailed cost and performance information. This information, preferably presented to the user in the form of graphs and reports, enables the user: to identify profitability on a detailed level (such as profitability relating to particular types of products, services and customers); to review benchmarking analyses; and to identify opportunities. A user can access and use the system on a network, preferably the Internet, and the system can provide the user with continued support, including automatic result updates. The system of the present invention facilitates the use of multi-driver cost systems such as activity-based costing for companies and other users.

While the present invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the appended claims. It should thus be understood that various changes and modifications to the presently preferred embodiments described herein will be apparent to those skilled in the art. Such changes and modifications can be made without departing from the spirit and scope of the present invention and without diminishing its attendant advantages. It is therefore intended that all such changes and modifications be covered by the appended claims.

What is claimed is:

1. A cost and performance system comprising:
at least one processor connected to at least one network;
at least one cost program readable by the processor;
at least one storage device electronically accessible by the processor;
the storage device including activity data;
the storage device adapted to receive user-specific data; and
at least one result generated by the processor for at least one user, the user being of any particular type,
whereby the system includes activity data associated with the user's type prior to the user's initial use of the system.

2. A cost and performance system comprising:
at least one processor connected to at least one network;
at least one cost program readable by the processor;
at least one storage device electronically accessible by the processor;
the storage device including activity data;
the storage device adapted to receive user-specific data; and
at least one result generated by the processor for at least one user,
whereby the system provides at least part of the activity data necessary to generate the result.

3. The system of claim 2, whereby the system provides a majority of the activity data necessary to generate the result.

4. The system of claim 2, whereby the system provides all of the activity data necessary to generate the result.

5. The system of claim 2, whereby the system provides all of the activity data necessary to generate the result derived from activity-based costing.

6. The system of claim 2, wherein the cost program includes at least one activity-based program.

7. The system of claim 2, wherein at least one portion of the activity data is associated with a particular type of user.

8. The system of claim 2, wherein different portions of the activity data are associated with different types of users.

9. The system of claim 2, wherein the user-specific data includes general ledger data.

10. A cost and performance system comprising:
at least one processor connected to at least one network;
at least one cost program readable by the processor;
at least one storage device electronically accessible by the processor;
the storage device including activity data;
the storage device adapted to receive user-specific data; and
at least one result generated by the processor for at least one user,
whereby, the user is not required to cause the system to be provided with at least part of the activity data in order to generate the result.

11. The system of claim 10, whereby the user is not required to cause the system to be provided with any of the activity data in order to generate the result.

12. The system of claim 10, whereby the user is not required to cause the system to be provided with a majority of the activity data in order to generate the result.

13. The system of claim 10, whereby the user is not required to cause the system to be provided with all of the activity data necessary to generate the result derived from activity-based costing.

14. A cost and performance system comprising:
at least one processor connected to a network which is accessible by a plurality of users;
at least one cost program readable by the processor;
at least one database accessible by the processor; and
activity data and user-specific data stored in said at least one database,
whereby the processor is adapted to generate different results for a plurality of different users.

15. The system of claim 14, wherein the cost program includes at least one activity-based program.

16. The system of claim 14, wherein the activity data is commonly associated with a plurality of users of one type, and the user-specific data is separately associated with each user.

17. The system of claim 14, whereby the processor, using the activity data and user-specific data, is adapted to generate results for a plurality of different users of one type.

18. The system of claim 14, wherein different portions of the activity data is separately associated with a plurality of users of different types, and the user-specific data is separately associated with each user.

19. The system of claim 17, whereby the processor, using the activity data and user-specific data, is adapted to generate results for a plurality of different users of different types.

20. The system of claim 14, which includes at least one conversion program readable by the processor.

21. A cost and performance system comprising:
at least one processor connected to a network which is accessible by a plurality of users;
at least one conversion program readable by the processor;
at least one activity-based program readable by the processor;
a plurality of databases accessible by the processor; and
activity data and user-specific data stored within at least one of the databases,
whereby the processor is adapted to generate different results for a plurality of different users which are associated with the activity data.

22. A method of providing information related to cost, comprising the steps of:
(a) connecting at least one processor to at least one network;
(b) enabling a user to access the network;
(c) accessing activity data;
(d) accessing user-specific data;
(e) converting certain data into a particular form;
(f) using the converted data to build at least one model; and
(g) using the model to provide information to the user.

23. The method of claim 22, wherein step (e) includes the step of calculating at least one allocation quantity.

24. The method of claim 22, wherein step (f) includes the step of calculating at least one activity overhead.

25. The method of claim 22, wherein step (f) includes the step of calculating at least one product overhead.

26. A method of providing access to information related to cost, comprising the steps of:
(a) storing activity data associated with at least one type of user;
(b) enabling the user to electronically provide user-specific data from at least one general ledger;
(c) processing at least part of the activity data and user-specific data; and
(d) enabling the user to access cost information related to activities.

27. The method of claim 26, which includes the step of storing activity data associated with a plurality of different types of users.

28. The method of claim 26, wherein step (c) includes the step of building at least one model.

29. The method of claim 26, wherein step (c) includes the step building at least one activity-based model.

30.The method of claim 26, which includes the step of enabling a plurality of different users to provide user-specific data from general ledgers.

31. The method of claim 26, which includes the step of enabling a plurality of different users to provide at least part of the activity data.

32. The method of claim 26, which includes the step of enabling the user to access cost information related to products or services.

33. The method of claim 26, which includes the step of enabling the user to access cost information related to customers.

34. The method of claim 26, which includes the step of enabling the user to access cost information related to opportunities.

35. The method of claim 26, which includes the step of enabling the user to access cost information related to performance.

36. A method of using a cost system, comprising the steps of:
(a) acquiring access to activity data;
(b) enabling at least one user to electronically submit user-specific data to at least one storage device;
(c) causing at least part of the activity data and user-specific data to be processed; and
(d) enabling the user to access cost information related to activities.

37. A method of causing a cost system to accommodate at least one type of user, comprising the steps of:
(a) collecting activity data;
(b) organizing the activity data;
(c) generating at least one cost driver; and
(d) modifying at least part of at least one program.

38. The method of claim 37, wherein step (c) includes the step of generating a plurality of cost drivers.

39. The method of claim 37, which includes the step of analyzing the activity data.

40. The method of claim 37, which includes the step of modifying the activity data.

41. A method of providing information to a cost system user, said method comprising the steps of:
(a) obtaining electronic access to activity data;
(b) enabling a user to electronically submit user-specific data to a storage device;
(c) converting at least part of the user-specific data into an activity-based format;
(d) building at least one activity-based model associated with at least part of the activity data and at least part of the user-specific data;
(e) outputting activity-based data;
(f) re-organizing at least part of the activity-based data;
(g) generating results for the user;
(h) enabling the user to electronically access the results; and
(i) enabling the periodic repeat of steps (b) through (h).
